(19) United States
(12) Patent Application Publication
(10) Pub. No.: US 2003/0148247 A1
(43) Pub. Date: Aug. 7, 2003

(54) Application and energy applying methods for root canal sealing material

(76) Inventors: Robert J. Sicurelli JR., Brooklyn, NY (US); Samuel Masyr, Brooklyn, NY (US)

Correspondence Address: ALFRED M. WALKER, 225 OLD COUNTRY ROAD, MELVILLE, NY, 11747-2712, US

(21) Appl. No.: 10/298,035

(22) Filed: Nov. 15, 2002

Related U.S. Application Data
(63) Continuation-in-part of application No. 09/990,932, filed on Nov. 21, 2001.

(51) Int. Cl. A61C 5/08; A61C 5/02

(52) U.S. Cl. 433/220; 433/224

(57) ABSTRACT

In connection with insertion of a post into a root canal, a simultaneous curing of the tangible sealing ma1terial aggregate is accomplished. Gutta percha or other sealing material is removably attachable to the apical end of the post and heat or other energy is applied to the post, either before and/or after the post is inserted into the root canal of the tooth being treated, to plasticize and condense the tangible sealing material aggregate. The sealing material is removably integral with the post, or removably attached to the post. In other cases, the tangible sealing material aggregate is provided in a tapered tip and is attached to the bottom of the post without heat or other energy sources, or by condensation, and is therefore attached as an uncondensed single point fill. When placed in the root canal, the tangible sealing material aggregate tip is held in place by typical root canal cements, such as eugenol based cements, resin based cements and glass ionomer cements.

### BACKGROUND OF THE INVENTION

The present invention generally relates to a dental post and core system for endodontically-treated teeth. More specifically, this invention relates to a passive dental post and core system having a flexible inelastic post, wherein the post is made from a material having a plurality of distributed fibers, such as, for example, medical grade optical fibers, other medical grade fibers or other fiberglass materials, which are held together in a matrix in a resin, such as a polyester resin or a vinyl ester resin.

In the preferred embodiment, the flexible post has a modulus of elasticity less than or equal to that of tooth dentin, to prevent widespread damage to a tooth in a traumatic event, when a conventional post would flex less than the tooth dentin, causing tooth fracturing where the flexible dentin violently contacts the inflexible conventional post.

Also in the preferred embodiment, the endodontic post of the present invention is cylindrical, rather than wedge shaped as in many non-metallic posts, because of its less stressful impact and its decreased wedging effect, which can cause immediate and/or residual root fractures.

While the fibers may be axially aligned, preferably at least one of the fibers extends non-axially aligned with respect to a straight axis extending from the apical end to the opposite coronal end of a root of a tooth.

In one embodiment, the present invention includes an endodontic dental reinforcement post for endodontic and reconstructive pin therapy comprising a prefabricated bundle of loosely compacted fibers in a cured resin, with the post extending from an apical end to a coronal end of a tooth canal.

For example, the fibers may be a bundle of fibers, a longitudinally twisted bundle, a twisted braid, a woven lattice, a helically wrapped bundle of fibers, or a composite of randomly dispersed fibers in a binder.

In this preferred embodiment, at least one of the fibers extends non-axially aligned with respect to the straight axis of a root of a tooth.

For example, in a bundle of fibers, while some of the fibers may extend parallel to the straight axis of the root, at least one or more of the fibers extend in an axial direction which is not parallel to the straight axis of a root of a tooth. That is, at least one or more of the fibers extends in a transverse or angled direction away from the straight axis of the root of a tooth.

With respect to a longitudinally twisted bundle, a twisted braid, a helically wrapped bundle of fibers, the twisting or helical wrap of the fibers causes many, but not necessarily all, of the fibers to extend non-axially. Concerning a woven lattice of fibers, while one set of fibers could extend axially parallel to the straight axis of the root, the other intersecting set of fibers extends in a direction which is non-axially aligned with respect to the straight axis of the root. Even if most of the weft of a weave of a plurality of fibers extends parallel to the straight axis of the root, at least one or more fibers constituting the warp of the weave of fibers extends non-axially with respect to the straight axis of the root of the tooth.

Moreover, concerning a composite of randomly dispersed fibers, there is always the possibility of one or more of the fibers being axially aligned to the straight axis of the root of a tooth. However, in order to be randomly dispersed, at least one or more of the fibers extends non-axially with respect to the straight axis of the root of a tooth.

Preferably, the post is radio-opaque and bears a color simulating that of a natural tooth.

Rigid dental post and core systems are widely utilized to restore endodontically-treated teeth. Post and core restorations are routinely used to create an adequate foundation for the final restorative step, which may be a crown, inlay, or a fixed partial denture abutment. Generally, a post is provided for retention and lateral stability of the restoration. The core provides support for the crown. Two general types of post and core systems are known in the art: “active” or screw-in type systems and “passive” type systems. Active post and core systems mechanically engage the walls of the root canal and tooth dentin. Passive post and core systems are bonded in endodontically treated teeth utilizing cements and the like.

Two major problems are encountered when restoring an endodontically-treated tooth. Firstly, the tooth is more susceptible to fracture, and secondly, there is generally less coronal structure with which to work. The greater susceptibility of a tooth to fracture after endodontia may result from the tooth being more brittle. However, studies of the changing mechanical properties of pulpless teeth do not generally support this theory equating dryness with reduced mechanical strength. It appears that the greater susceptibility for fracture in an endodontically-treated tooth results from mechanical weakening of the tooth during root canal therapy and refinement of the root canal. Improvements in restoration techniques that reduce mechanical weakening are therefore desirous.

An endodontically-treated tooth is generally severely compromised either due to trauma or neglect. Thus, traumatic fractures, removal of old restorations and carious tissue, and preparation of root canal access may not leave enough tooth to maintain the “dome effect” of the tooth or to retain a crown.

The stress concentrations in a tooth resulting from the rigid post and core systems of the prior art also play a vital role in tooth fracture. Stress concentrations can be impacted through system design and/or restoration techniques. Various studies and investigations into the susceptibility of endodontically-treated teeth to fracture and the contribution of rigid dental post and core systems to such fracture have been conducted. “A Comparison of Intracanal Stresses in a Post Restored Tooth Utilizing the Finite Element Method”, Cailleteau, Johnny G., Rieger, Monty R. and Akin, J. Ed, Journal of Endodontics, Vol. 18, No. 11, November 1992, pp. 540-544, reports that placement of a rigid post within a tooth alters the pattern of stress along the root canal as compared with an intact tooth. Instead of strengthening the tooth the post stiffens the coronal posted section and shifts the flexure point apically. The effect of this stiffening causes the non-posted apical portion of the tooth to deform at the post apex, resulting in a stress increase in that portion of the canal wall. Also, the cyclic loading and unloading of an incisor during mastication requires consideration of fatigue failure. Since the maximum bending stresses occur in connection with the apex of the post, any inclusions or defects within the wall of the dentin near the apical end of the post would create stress concentrations that increase the risk of a fatigue crack formation. Defects and microfractures introduced during endodontic treatment and post access preparation could become areas contributing to stress concentrations. Studies have also shown that more intact tooth structure provides better resistance to fracture than a metallic post. There is also evidence that stresses in the tooth tend to increase as the post diameter increases.

A flexible post eliminates these problems and a cylindrical flexible post performs even better. A post and core system utilizing a flexible post shifts the stress concentrations coronally, eliminates the introduction of defects during post access preparation and post placement, and leaves more of the tooth intact.

The main function of a post is to provide retention to the core. Relieved of its expectation to facilitate resistance to tooth fracture, the post can be designed to optimize its retentive properties. Several factors govern the retentiveness of endodontic posts. The shape of the post and its length are among the essential factors.

For example, unlike the preferably flexible cylindrical post of the present invention, tapered dowels have been found to be significantly less retentive than parallel-sided posts. While inflexible metallic posts are generally cylindrical and/or threaded, non-metallic resin-based posts are generally tapered, such as described in French Patent Publication No. 8,515,527 of Barbe et al, published Apr. 10, 1987 or U.S. Pat. No. 5,326,263 of Weissman, where a tapered cylinder is seated within a wide tapered resin base. Such tapering was believed to enhance removal of a first temporary post to be replaced by a permanent post. Weissman '263, also describes a temporary flexible post including a single fiber optic cable rod, which is removed from a reamed, wedged shaped drilled out tooth canal before installation of a permanent, inflexible post. The post of Weissman '263 also has the drawback of being smooth on its surface, to facilitate easy removal of the temporary post.

Weissman '263 also describes a flexible tapered post insertable within a converging, tapered, canal wherein the converging tapered canal is filled with a curable composite. It lacks any texturization of the surface, which helps to maintain a permanent post in position within a tooth canal.

U.S. Pat. No. 5,165,893 of Thompson discloses using a fiber optical plunger applicator to apply a liner adjacent to the inner surfaces of a root canal. It does not describe a permanent post as in the present invention.

A serrated 5.5-mm parallel-sided dowel was found more retentive than an 8-mm tapered post. Tapered posts, such as described in Barbe noted above, provide high shoulder stresses but have an undesirable wedging effect. The wedging effect results in part from the prior art placement of a straight rigid post in a naturally curved and varying diameter root canal.

Furthermore, active threaded posts are very retentive, but may impose too much stress on the tooth, especially compromised teeth.

Thus it appears that a flexible passive, textured, parallel-sided cylindrical post is a preferred structure for dental post and core systems. A flexible, passive, textured parallel-sided cylindrical post provides the previously-mentioned advantages in preventing tooth fracture and additionally permits the post to extend for a greater length into the root canal for improved retention.

In addition to post shape and length, adequate retention is a function of cementing mechanisms. Various cementing medium have been studied. Utilization of low viscosity resin cement in combination with smear layer removal can be considered a universal post cementation technique. In addition to good retention, this cementing technique offers the benefits of a cement with very little resistance to post insertion, thereby minimizing stresses applied to tooth structure during cementation. However, the invention of the present disclosure is not limited by the cementing process used.

Nevertheless, light sensitive cements, such as REVOLUTION®, of E.N.D. Dental Products Company, Somerset, N.J., can only act when used with a translucent substance. Therefore, there is a need for a translucent endodontic post as well.

A major problem of dental posts for endodontic root canal therapy is the inelasticity of posts, even if partially flexible. For example, stainless steel posts have a GPa (giga Pascals) of approximately 190, and titanium posts have a GPa of approximately 100, wherein the higher the GPa number the less elasticity of the post. One attempt to solve this problem is a non-metallic, carbon fiber, unidirectional post known commercially as C-POST® of Bisco Company of Itasca, Ill.

However, its modulus of elasticity is approximately 21, as reported in product literature therefor, whereas natural tooth dentin has a lower modulus of elasticity of 18. Since the modulus of elasticity of the C-POST® exceeds the modulus of elasticity of natural tooth dentin in which the C-POST® is inserted, the C-POST® may cause a tooth to fracture because the C-POST® is less elastic than natural tooth dentin.

Therefore, there is an unsolved need for an endodontic post for root canal therapy wherein the post has a modulus of elasticity less than that of natural tooth dentin. As a result, such a post would have less a likelihood of fracture, and will reduce the need for subsequent re-doing of post and core therapy after a post fractures or extraction of any non-restorable teeth.

Other background art includes an elastic, wire pin having a plurality of flexible, radially extending fins along its length, as is disclosed in German Patent No. DE 3,643,219 to Weisskircher. While providing some advantages over the prior art rigid post, the “high degree of elasticity” of the Weisskircher pin will cause it to try and retain its initial shape in the root canal. During and after placement, flexing of the pin will cause the apical end of the pin to lay against the wall of the root canal. Stress concentrations in the tooth as known for rigid posts will thereby be induced. A pin formed from wire also has low retention characteristics and tends to rotate within the root canal. Radial fins are utilized in the Weisskircher disclosure to resist rotation of the wire pin. However, these radial fins may become further sources of stress concentrations and fatigue failure as the wire pin rotates. No prior art known to the present Applicants discloses or suggests a flexible post in a dental post and core system that is flexible and inelastic, i.e., that conforms to the shape of the root canal to eliminate the stress concentrations that facilitate tooth fracture.

Furthermore, U.S. Pat. No. 4,778,389 to Salvo discloses a dental post construction to eliminate lateral stress in a tooth wherein a rigid, split post is formed by parallel sections joined at a marginal top portion of the post head.

U.S. Pat. No. 5,073,112 to Weil discloses a dental post having an active portion and a passive portion. It also describes a combination sleeve and threaded post, wherein part of the post is threaded, and part is not threaded. A temporary light transmitting rod is inserted to provide light to a light activated composite cement.

U.S. Pat. No. 5,074,792 to Bernadat discloses a passive post and core system comprising a rigid peg disposed in a porous sheath formed of high-strength filaments, wherein the peg has a set of parallel radially extending fins extending from the peg. The filaments in Bernadat are found in the sheath surrounding the peg, not in the peg itself.

U.S. Pat. No. 732,922 of Clark describes a pin for teeth which is flexible, but only by virtue of the fact that the pin includes a base and two tapered pins extending from the base, with a space therebetween, so that the tapered pins can close toward each other within the space.

U.S. Pat. No. 4,952,150 of Schiwiora discloses a tooth root post which includes a tip of solid flexible metal or metal alloys. In contrast to Schiwiora '150, in the present invention, the root post is made of a plurality of metallic or non-metallic fibers, as opposed to a solid piece of metal.

U.S. Pat. No. 4,934,936 of Miller describes a serrated dental post. U.S. Pat. Nos. 622,670 of Dwight and 1,218,289 of Maker both disclose solid threaded posts with a core spacer neck extending therearound.

International Search Publication No. WO 91/07142 (PCT/FR90/00831) to Reynaud et al., which also issued as U.S. Pat. No. 5,328,372, discloses a dental post and core system having a post formed from equally-tensioned fibers of composite material. In Reynaud, the fibers of the composite material are all laid axially within the post and embedded within a resin. Because the fibers are equally tensioned and extend only axially aligned and continuous, any modification of the post in Reynaud may cause a major spreading, continuous, fault line crack in the resin of the post, thus losing integrity of the Reynaud post.

In contrast to Reynaud '372, as noted hereinafter, in the present invention the fibers are loosely compacted and cured in a resin, and not pre-tensioned and stretched under tension by traction, as required in Reynaud et al, as noted in the specification therein.

In further contrast to Reynaud et al, preferably at least one or more of the fibers extends in a direction which is non-axially aligned with respect to the straight axis extending from the apical end to the opposite coronal end of a root of a tooth. Because there is a plurality of directions with respect to the fibers, such as at least one fiber running non-axially, the possibility of a spreading, continuous fault line crack is significantly reduced, thereby achieving unexpected beneficial results not suggested in Reynaud '372. Also, while the Reynaud '372 post can be cut in length, it is contraindicated to shave or adjust the Reynaud '372 post in all directions so that the possibility exists of causing the carbon rods to develop axial fault crack lines.

Other background art includes U.S. Pat. No. 4,936,776 to Kwiatkowski, which discloses a translucent post and core structure to minimize gingival discoloration adjacent a dental restoration, and U.S. Pat. No. 3,949,476 to Kahn discloses a “direct” method of restoring an abraded or broken tooth.

Soviet Union Patent No. SU 1,457,914 of Feb. 15, 1989, to Stomatology Research Institute discloses a method of making a pin stump insert. Moreover, Soviet Union Patent No. SU 1,519,684 of Nov. 7, 1989 describes a threaded grooved tooth implant. Furthermore, Soviet Union Patent No. SU 1,277,950 of Dec. 23, 1986 discloses an electrochemical bonding procedure for coating dental pins.

West German Patent No. 1,541,209 to Kurer discloses the now conventional threaded, screw-in type active post.

U.S. Pat. No. 4,622,012 of Smoler describes a two part dental post system with an outer hollow sleeve post and an inner post insertable within the outer post.

U.S. Pat. No. 4,759,718 of Szeguary describes an active threaded post. U.S. Pat. No. 4,726,770 of Kurer, Swiss Patent no. CH669514 of Polydent, U.S. Pat. No. 4,696,646 of Maitland, and U.S. Pat. No. 4,631,030 of von Weissenfluh, all describe interproximal contact wedge tools for filling cavities in a tooth.

U.S. Pat. No. 5,088,927 of Lee describes a dental plastic member impregnated with metal to enhance x-ray pictures. U.S. Pat. No. 5,030,093 of Mitnick discloses a dental restoration apparatus including a material setting tool which includes an optical probe. U.S. Pat. No. 5,092,773 of Levy describes an apparatus for filling the apex of a root canal with a laser mettable material. U.S. Pat. No. 5,116,227 of Levy describes a laser operable canal forming tool.

French patent application no. FR 2,645,431 of Levy describes a laser tool for cleaning a root canal.

German Patent No. DE 3,411,366 of Neumeyer describes an optical probe for periodental treatment.

U.S. Pat. No. 4,684,555 of Neumeyer describes dental retention pins made of metal, plastic, porcelain or ceramics. However, Neumeyer '555 includes two layers, an inner layer and an outer coating layer. This is in contrast to the present invention, in which there is an even distribution of fibers through the endodontic post. As a result, the post of the present invention requires no outer bond assisting or enhancing layer, as is needed in Neumeyer '555. Furthermore, Neumeyer '555 is not concerned with providing a pin having a modulus of elasticity less than tooth dentin, as is the endodontic post of the present invention.

Other prior art includes U.S. Pat. No. 4,645,457 of Goldman which describes a method of cleaning a root canal prior to installation of a post therein and U.S. Pat. Nos. 4,990,090 and 5,145,373, both of Roane, which describe grooved and/or threaded endodontic posts.

U.S. Pat. No. 5,320,530 of Fong describes an endodontic apparatus for retrofill cavity preparation and U.S. Pat. No. 4,172,867 of Devault describes an index pin and die spacer combination for dental use.

Furthermore, U.S. Pat. No. 5,407,973 of Hasegawa describes a dental cold-polymerizing resin composition and U.S. Pat. No. 5,284,443 of Weil describes a method of inserting a removable light transmitting mandrel point temporarily within a deposit curable composite material, wherein the light transmitting member provides light to cure the material.

In addition, U.S. Pat. No. 5,007,837 of Werly describes a method of filling a cavity and U.S. Pat. No. 822,582 of Carmichael describes an attachment for natural teeth and method of forming the same. U.S. Pat. No. 4,778,388 of Yuda et al describes root canal posts.

European patent application publication no. 0076086 of Carse dated Apr. 6, 1983, describes a threaded dental pin having a threaded pin member and a synthetic resin having a sharing neck 18.

British Patent No. 1,302,022 of Technical Dental Developments dated Jan. 4, 1993 describes an improved dental crown which uses resin with metal particles for casting a crown. It is not for a permanent post.

French Patent publication no. 2,626,167 of Himmel assigned to Compodent Research and Applications Ltd., dated Jul. 28, 1989, also known as British Patent No. GB 2,214,087, describes a dental post pin and a method of making the pin. The dental post pin essentially includes a central filament of yarn which is axially aligned within a sheath of fiber containing resin. Himmel also describes a plastic, ceramic, carbon or glass central wick or filament surrounded by an outer sheath of resin which could have other fibers in it.

In contrast, in the present invention, the fiber bundles preferably are equally dispersed throughout the peg of deposit and are not limited to the central portion. Also, in the present invention, there is no differential of an outer sheath having denser fibers from the loosely packed fibers of the central core.

French Patent publication no. 2,587,197 of Reynaud dated Mar. 30, 1987, and U.S. Pat. No. 4,738,616, also of Reynaud, describe dental posts which are made up of a serial of conical parts that are joined together in a cylindrical conical fashion.

German patent no. DE 3,825,601 of Strobl dated Aug. 9, 1989, describes a dental reconstruction post for endodontics, wherein a fiber reinforced plastic is used. However, there is no mention of the need for imparting flexibility in the post. In Strobl, the fibers are used specifically to strengthen the post and increase rigidity, not to make the post more flexible, as in the post of the present invention.

For example, in paragraph 3 of the section of the patent application of Strobl entitled “State of Technology, with Sources”, it is stated that the strength and rigidity of plastics can be increased significantly by incorporating high-strength fibers with a high modulus of elasticity.

In contrast, the endodontic post of the present invention has a low modulus of elasticity, and is thus flexible.

Furthermore, Strobl teaches a wedge shaped post, which increases wedging stress within the tooth. While Strobl discloses rigid, diagonally extending non-axially fibers in the crown stump attached a post, in the post itself the fibers are described as lying in the direction of the root pin, i.e. axially, unlike the preferred embodiment of the present invention.

French Patent publication no. 1,457,914 of Badische dated Dec. 8, 1965, describes a thermal plastic material.

Currently-marketed dental post and core systems such as the FLEXI-POST®; the DENTATUS POST®, the RADIX POST® and the BRASSELEAR® screw posts all advocate screwing threaded rigid posts into straight paths machined into the tooth dentin. These present day posts are also generally formed from rigid metals such as steel, titanium and other alloys which do not flex in the same manner as a natural tooth. As noted before, this differential in flexibility between the natural tooth and the post may cause tooth fracture when the restored tooth is stressed during mastication or from trauma. These cast posts are subject to the same limitations and require an additional laboratory fee and an additional visit to the dentist to complete the procedure.

A means to quickly and easily identify the components of a post and core system is also needed in the prior art. Presently, there is either no color-coding of post and core systems or the color identification consists of an inconspicuous dot of color. Brightly-colored means of identifying post and core systems would significantly advance the art. The lack of a color protocol in the prior art creates confusion, eye strain and a sloppy work environment. The inability to readily identify each post and core by sight creates problems before, during and after the procedure is completed. Firstly, before the procedure is initiated the dentist and staff must select the post and core and isolate it from others that may be very close in size. During the procedure the dentist must carefully avoid confusing the selected post and core. After the procedure the used and unused devices must be readily identified for contamination control. Further, a post and core system installed by one dentist may later require an emergency or other procedure by a different dentist in a completely different part of the world. Color-coded identification would eliminate uncertainty and guesswork.

Furthermore, during a root canal procedure, it is necessary to seal the open apex of the root canal with a sealer, such as gutter percha. Traditionally this sealing task is done in a separate step, whereby the gutta percha material is inserted into the apical end of the root canal and heated and/or condensed to seal the apex of the root canal. In some cases the gutta percha is inserted without being subject to heat or condensation pressure, and is held in place by root canal cement to the root canal wall. Typical root canal cements include eugenol based cements, resin based cements and glass ionomer cements, among others.

Among related patents for heating gutta percha before an endodontic post is inserted into a canal include U.S. Pat. Nos. 6,106,283 of Roffe and 6,270,343 of Martin, which describe heating units for intra-canal heating of gutta percha.

U.S. Pat. No. 6,168,432 of Marlin describes a needle for injecting heated thermoplastic material into a tooth canal, and U.S. Pat. No. 6,254,389 of Seghatol, which discloses a hand held microwave heater for curing polymers used in dentures and other restorative structure.

U.S. Pat. No. 6,433,037 of Guzaukas discloses pre preg polymers for preparing dental materials in a laboratory.

Pre preg materials are also used in producing marine structures with complex curves, such as kayaks, wherein fibers in a resin are partially cured in a malleable state and then vacuum sealed in a package, which opened when the fibers and resin are applied to the kayak structure and are further cured by heating in an oven or autoclave.

U.S. Pat. No. 6,447,297 of Lopez describes an endodontic post which is ground or machined at its apical end to produce a thin, pointed apical end, around which is applied a tapered cone of gutta percha. Before the post is inserted within the canal, the gutta percha might be heated outside of the patient's month, and then the post is inserted into the canal while the gutta percha or other sealing material is malleable; or the post and gutta percha inserted without prior thermoplastization. First, it is noted that Lopez '297 asserts that prefabricated dental posts can be made of reinforced fibers in a resin, according to the teachings of U.S. Pat. No. 4,894,012 of Goldberg or U.S. Pat. No. 5,919,044 of the Applicants Sicurelli and Masyr herein. However, while Sicurelli '044 describes a non-metallic fiber post in a resin, Goldberg '012 does not. Goldberg '012 is concerned with custom, patient-specific members such as dentures and bridgework, which span from tooth to tooth, creating a customized prosthesis that can only fit one patient, and which is not a prefabricated intra-radicular fiber and resin post, as in Sicurelli '044, which fits all teeth. This matter has been previously resolved in the U.S. Patent Office in the file history of Sicurelli '044, which discusses Charbeneau et al, Principles and Practices of Operative Dentistry (1981), pp 446-448 and Tylman, Crown and Bridge Prosthesis, Chapter XLII, pp. 871-885 as distinguishing prefabricated posts from customized patient prostheses.

Furthermore, Lopez '297 has its disadvantages. The thin, machined carrier tip of Lopez '297 can accidentally push through the apex of the root canal, causing acute apical periodontitis or other complications and post operative pain. Since it has no positive stop that prevents pushing it beyond the apex, the thin carrier tip can pop a large hole into the periapical tissue area below the tooth. Also, the thin carrier tip of Lopez '297 allows filler material to possibly retract away from the carrier tip, causing material gaps and uneven condensation of the sealing material. The carrier tip can cause a deflection with subsequent uneven distribution of the filling material. Furthermore, the tapered carrier for the sealing material of Lopez '297 is an extension of the main endodontic post, and is therefore not malleable itself. Therefore it invades the apical end of the tooth with a rigid pointed member that may damage the apical end of the tooth.

To avoid the problems of invading into the periapical tissues below the tooth, such as may occur with Lopez '297, Applicants' U.S. Pat. No. 6,024,565 describes an endodontic measuring system which includes a plurality of user selectable elongated cylindrical diameter measuring rods having graded diameters known to the user for insertion as probes into an endodontic canal wherein the diameter of the natural lower root tip aperture and length of the tooth canal from apical to coronal end are to be determined. The kit also has a plurality of user selectable elongated tapered rods having graded diameters, wherein the tapered rods each have a top cylindrical portion with optional length measurement markings thereon for observing too the depth from the upper coronal crown end to the lower root apical tip aperture. The tapered rods have a tapered bottom end extending from the top cylindrical portion, and the tapered bottom end has a visual indicator for indicating contact made between the tapered bottom end and the natural contour of a lower endodontic root tip aperture whose diameter and whose length of the tooth canal from apical to coronal end are being determined, prior to endodontic root canal treatment.

### OBJECTS OF THE INVENTION

A primary object of the present invention is therefore to provide a flexible, inelastic dental endodontic post with a modulus of elasticity less than natural tooth desin.

A further object is to provide a dental post which can be installed with a seal for the apex of the root canal.

Another object of this invention is to provide a passive and bondable dental post and core system for endodontically-treated teeth.

Yet, another object of this invention is to provide a dental post and core system that reduces the susceptibility for tooth fracture in endontically-treated teeth.

A further object of this invention is to provide a method for restoring endodontically-treated teeth that reduces the susceptibility for tooth fracture.

Another object of the present invention is to provide a dental post and core system that reduces the mechanical weakening of tooth structure by relieving stress concentrations.

Another object of the present invention is to provide a dental post and core system that reduces the risk of a dentist creating perforations and microfractures during post placement.

It is also an object of the present invention to provide a flexible post in a dental post and core system that automatically adjusts to the contours of a root canal during placement.

Another object of this invention is to provide a post and core system having a flexibility that closely mimics the flexibility of the pulp and dentin tissue of a natural tooth.

Another object of the present invention is to provide a dental post and core system that reduces the amount of time required to restore an endodontically-treated tooth.

It is also an object of this invention to provide a dental post and core system that can be safely and quickly installed by any dentist in a single visit.

Another object of this invention is to provide a dental post and core system formed from material that can be readily shaven to accommodate canal irregularities and in-between root canal sizes without loosing its physical properties.

Another object of this invention is to provide a dental post and core system that is radio-opaque.

Another object of this invention is to provide a method of restoring endodontically-treated teeth that eliminates or nearly eliminates drilling for post placement and that can be installed using inexpensive, readily available endodontic drills.

Another object of this invention is to provide a post in a dental post and core system that fits intimately within a root canal and that accepts standard dental cements.

Another object is to provide a color-coded dental post and core system for identification purposes.

A further object of the present invention is to provide dental post and core system that substantially fits all teeth.

It is another object of the present invention to provide a dental post and core system that can be provided in standardized sizes for mass production efficiencies.

A still further object of this invention is to provide a restoration system of flexible dental pins for teeth previously classified as hopeless and difficult, such as hemisected and dilacereted teeth and other conditions of extreme loss of tooth structure.

These and other objects and advantageous of the improved dental post and core system of the present invention will be apparent to those skilled in the art from the following description of preferred embodiments, claims and appended drawings.

### SUMMARY OF THE INVENTION

In keeping with these objects and others which may become apparent, the present invention is a dental post and core system that includes an inelastic flexible post of a bundle of fibers, such as medical grade optical fibers or other fiberglass fibers held together in a resin, such as a polyester resin or a vinyl ester resin.

In contrast to Reynaud '372 in the present invention the fibers are loosely compacted and cured in a resin, and not pre-tensioned and stretched under tension by traction, as required in Reynaud '372, as noted in the specification therein.

The flexible post conforms to the curvature or path of the root canal during placement and reduces mechanical weakening of an endodontically-treated tooth by eliminating stress concentrations at the apical end of the post, by reducing the size of access preparations and by allowing more intact tooth to be retained.

The present invention also provides a method of restoring an endodontically-treated tooth that reduces the time and equipment needed during a procedure and lessens the chance that a dentist will perforate or fracture the canal wall during placement of a post.

The present invention solves the problems of rigid, inflexible inelastic dental posts for endodontic root canal therapy. For example, stainless steel posts have a GPa of approximately 190 and titanium posts have GPa of approximately of 100 wherein the higher the CPa the less elastic is the post. As noted above, the C-POST® of Bisco Company of Itasca, Ill. is a carbon fiber unidirectional post in an epoxy matrix. However the modulus of elasticity of the C-POST® is approximately 21 whereas the modulus of elasticity of the natural dentin in a tooth is 18. Since the modulus of elasticity of the C-POST® exceeds the dentin it is still subject to fractures because it is less elastic than the natural dentin in the tooth itself.

Therefore while the present invention may closely approximate the modulus of elasticity of tooth dentin, in a preferred embodiment the present invention is directed to an endodontic post for root canal therapy wherein the post has a modulus of elasticity which is less than that of natural tooth dentin. As a result there is a less likelihood of fracture of the post, which avoids a complete extraction of the tooth or need for unnecessary surgery.

One embodiment of the present invention includes using medical grade optical fibers of high optical clarity with high pixel counts of between 50 and a 100 thousand, in a twisted bundle of the linearly extending fibers. Another embodiment uses a twisted bundle of other fiberglass fibers.

The purpose of the slow twist in a bundle of the fibers is as noted in Applicants' prior patent applications, wherein fracture of dental posts can be reduced by removing axial orientation of the fibers in one direction such as in Reynaud or in the C-POST® of Bisco.

The medical grade fiber optic fibers are traditionally used in optical cables which are normally used in the human body for endoscopic visual examination of internal organs through a tube through which the fibers extend.

In this embodiment, the posts of the present invention are made of silica-based fibers, bundled together, having a pure silica core of SiO₂. An example of the silica based fibers are medical grade optical fibers from Polymicro Technologies Inc. of Phoenix, Ariz.

The coating of each fiber is a polymer, such as KYNAR® (polyvinylidene fluoride) brand resin, or other resins, such as a polyimide, to impart flexibility to the glass fibers. The coating preferably is chemically or mechanically stripped, so it pulls light out transversally through the stripped apertures along edge of the post. This is beneficial when using a light sensitive adhesive which reacts to light. Typical light activating dental cement in the root, which is adjacent to the posts, include REVOLUTION® bonding light cement of END Dental Products Company of Somerset, N.J. Other non-light activating dental cements include chemical resins, such as SCOTCH BOND® of 3M Corporation of Saint Paul, Minn., or vinyl ester resins.

In the preferable embodiment the silica-based post fibers are coated with PVDF resin which meets USP class VI pharmaceutical standards. Such a resin is known commercially as KYNAR® (polyvinylidene fluoride). KYNAR® (polyvinylidene fluoride) fluoro-polymers are strong, as reflected by their tensile properties and impact strength. They have an excellent resistance to fatigue. However, they are useful in endodontic posts since they are flexible and light transmitting, and they are resistant to mechanical stresses. According to ASTM test D638 they have tensile strength of 5,000 to 6,500 psi yield. They have a tensile modulus according to ASTM test D882 of 150 to 200×10³ psi.

Moreover, the crystalline state of the KYNAR® (polyvinylidene fluoride) brand resins can be modified in rapid cooling to promote smaller crystalline size with increased crystallinity of their higher values for yield strengths. The KYNAR® (polyvinylidene fluoride) polymer and KYNAR® (polyvinylidene fluoride) flex co-polymer grades are in compliance with U.S. Pharmacopia (USP) classification VI.

In an alternate embodiment, E-glass fiberglass fibers are used as a substitute for the silica optical fibers. E-glass is commonly used in the electronics industry; a typical composition is 55% SiO2, 16% CaO, 15% A1203, 10% B203 and 4% MgO. This composition can be altered to achieve preferred properties for this application as described above.

While other size fibers may be used, a typical fiber of the group making up the bundle of fibers, is one thousandth of an inch in diameter. Therefore, a bundle of two hundred fibers has a diameter of approximately 0.05 inch. The final post peg may therefore be also 0.05 inch in diameter, including approximately 200 fibers plus the saturation of the epoxy binder with an optional colorant/opaquer mixed into the epoxy resin to modify and change these properties.

As an alternative to adding an opaquer mix into the epoxy resin, one or more metal fibers or wires at or near the center of the fiber bundle can be used. This would have the added advantage of providing a ready means to remove the post (if this were necessary) by the following method. The single centrally located wire or fiber can be pulled out leaving a pilot hole for guidance of a reamer to facilitate removal.

A preferred embodiment for an epoxy resin in MASTER BOND® Polymer System EP21LV of Master Bond, Inc. of Hackensack, N.J. MASTER BOND® is a two component, low viscosity epoxy resin in which the fibers are cast. The rigidity of MASTER BOND® can be adjusted by adjusting the mix ratio of the two components. Other useful resins include polyester resins or vinyl ester resins. Depending upon the adjustment of the epoxy resin, the number of fibers can vary.

Preferably the bundle of fibers have a rounded end and may also have a tapered end with an optional continuous groove or facet of 50 to 100 micron depths to increase surface texturing. The standard length of the post is about ⅝ inch and the standard diameter is about 0.04 inch to 0.05 inch, with an optional taper at the top with ⅛ inch linearly. The texturing may be by a die drawn across linearly or axially of 50 to 100 micron depth or it may be etched with acid or laser lights such as carbon dioxide laser or Yag laser or there may be an outer skin sheath added which is texturized. The individual fibers in one post in bundles are optionally twisted or gathered as they come off a spool.

Optionally the post may be tooth colored by adding barium sulfate to the epoxy resin that holds the bundle of fibers together such as in a medical grade epoxy such as bisGMA.

Among other uses for which the fiber based posts may be used is as a dental cavity reconstructive pin to replace titanium, steel, or gold pins which tend to corrode and which do not have a good modulus of elasticity.

This optional use for the fiber based post is as a reconstructive pin for a tooth with large areas of decay or traumatic damage. Such a tooth may be reconstructed using pins as a lattice scaffolding to stabilize the filling. Most prior art pins are metallic which has colorization problems. Furthermore, the flexible pin of the present invention can be looped around and closed into the tooth wherein the canal is back filled with composite material. The looping helps with retention by exerting a lateral force against the inside of the canal to provide an anti-rotational feature for both the post and the pin, wherein the axially extending surface facet is cut.

Other possible uses of the present invention are for hip prosthesis, finger joint restoration or other types of bone implants, to reduce resorption bone dissolution due to stress or infections.

In summary, while in some embodiments, the modulus of elasticity of each post is above, but close to, that of tooth dentin, the preferred embodiment has a modulus of elasticity which is less than that of the tooth dentin, which is about 18 GPa (giga Pascals).

In contrast to this embodiment of the present invention, in the Weissman '263 post, the reamer does not require any specialized shape at its end as long as its diameter is essentially the same as the diameter of the posts. The Weissman '263 posts are easily deformable. Also Weissman '263 describes a temporary fiber optic rod which is removable from a central channel.

In contrast, the present invention is a permanent, flexible post which has fiberglass fibers, or medical grade optical glass fibers, making it an integrally strong post. The micro filaments of the present invention may be treated by coating to impart flexibility and strength to each fiber. This is not done to add flexibility to the unit post but is done to effect the twisting or other non axial arrangements of the fibers to impart strength to the unit post. This allows it to function as a permanent post in all teeth, not only as a temporary post as in Weissman '263. Furthermore, the Weissman '263 post requires a composite cement or encasement, which is polymerized by using a bonding light, whereas the present invention can use either a light activated cement or a chemically cured cement, such as a glass ionomer which requires no photo activation.

Moreover, in the preferred embodiment of the present invention, the post is textured to keep it bonded in the canal, whereas the Weissman '263 post has a smooth surface to intentionally allow it to be removed because it is a temporary post. It has only been suggested to use the Weissman '263 post as a permanent post in compromised teeth, because the Weissman '263 post may lack mechanical properties such as tensile shear and compressive strengths.

In another embodiment of the dental post and core system of the present invention, the post includes a core spacer and a flexible, post reinforcing rod extending apically from the core spacer. The core spacer may be flexible, resilient or otherwise deformable and may be selectively attachable or integrally formed with post reinforcing rod. A core may be selectively attached to the upper portion of the core spacer, integrally formed with the core spacer or built-up to custom specifications.

A further embodiment of the present invention is a mutable flexible post. The mutable post of the present invention comprises a bundle of fibers that may be selectively flared at the coronal aspect to provide a core seat or to provide extra surface area to scaffold a core.

Conventionally, an endodontic procedure or root canal is completed by sealing the tooth's apex with gutta percha which is effected in a separate step when a dentist heats or prepares the sealing material before inserting the post, which can be metallic or non-metallic.

In contrast, in the method of the present invention, with respect to the post being inserted in the root canal cavity, a single curing step of the tangible sealing material aggregate is done in connection with simultaneous insertion of the post, wherein the gutta percha or other sealing material is removably attachable to the apical end of the post. For example, heat or other energy is applied to the post, either before and/or after the post is inserted into the root canal of the tooth being treated, to plasticize and condense the tangible sealing material aggregate which is removably integral with the post, or removably attached to the post.

In other cases, the tangible sealing material aggregate is provided in a tapered tip and is attached to the bottom of the post without heat or other energy sources, or by condensation, and is therefore attached as an uncondensed single point fill by one or more detents, by a press fit or by one or more small barbs. When placed in the root canal, the tangible sealing material aggregate tip is held in place by typical root canal cements, such as eugenol based cements, resin based cements and glass ionomer cements, among others.

Typically, a 4-6 mm cone of gutta percha or other tangible sealing material aggregate is all that is required to seal the apical end of the root canal of the tooth being treated.

In a further embodiment, the malleable tapered end of the post or the entire post itself can be made of a pre preg material which is partially cured with a resin at the manufacturing site and vacuum sealed in a package. Upon opening the package just before insertion into the root canal, the pre preg post is cured spontaneously, or by chemical or other curing means, such as the application of heat or other energy sources, such as ultrasonic, microwave, optics or vibration.

In that manner, the separate sealing of the root canal with tangible sealing material aggregate, such as gutta percha, is not required as a separate step, before insertion of the endodontic post into the canal. Rather, the present invention provides for the sealing of the canal with tangible sealing material aggregate attached to or otherwise provided integral with the post before insertion.

In one embodiment, the improvements of the present invention include the insertion of a heat or other energy conductive wire in the middle or thereabouts of the post, to transmit heat or energy to the gutta percha or other sealing material provided at the tapered apical bottom of the tooth root canal, into which the endodontic post is to be inserted.

Alternatively, the post can be cured by optics, ultrasonic, microwave by other energy sources or by chemical reaction, such as in a part A catalyst and part B base reaction, as seen in some resin and epoxy formulation reactions.

The preferred embodiment is tapered to adapt to the shape of the canal in the apical area and attached to this apical end is a short length of root apex tangible sealing material aggregate e.g. gutta percha, composite, resin, glass ionomer etc., that is restrictively malleable.

In one embodiment, the inside of the post has a wire. The function of the wire is to allow heat or energy transfer through the post to the gutta percha, plastic, etc., at the apical end. This heat or energy plasticizes the gutta percha or plastic, etc., which softens it and allows it to be pressed against the apex of the root thereby sealing the apex.

The new procedure of the present invention allows the post to be cemented and the root apex sealed in one step at the same time.

The wire can be made from nickel-titanium alloys, steel, gold and other suitable materials. The post can be tapered or cylindrical. The gutta percha end can be tapered or cylindrical, matching existing instrumentation and ISO sizes.

The gutta percha or another sealer material that is attached to the apical end of the post seals the apical end of the root canal. The post can be a cylinder but the preferred embodiment is tapered at the apical end.

In contrast to Lopez '297, the present invention provides the gutta percha or other sealing material in a malleable tip, without a sharp carrier tip, which might protrude through the apex of the root canal and cause complications in the periapical tissues below the tooth or uneven distribution or condensing of the filling material against the apex of the root canal.

### BRIEF DESCRIPTION OF THE DRAWINGS

The present invention can best be understood in conjunction with the following drawings, in which:

FIG. 1 is a lateral cross-sectional view of the first preferred embodiment of the dental post and core system of the present invention;

FIG. 2 is a lateral cross-sectional view of a first preferred embodiment of the present invention in a double-canal tooth;

FIG. 3 is a perspective, exploded view of a first core spacer and a first post reinforcing rod of the present invention;

FIG. 4 is a lateral cross-sectional view of a second post reinforcing rod constructed in accordance with the teachings of the present invention;

FIG. 5 is a partially cross-sectioned perspective view of a third post reinforcing rod constructed in accordance with the teachings of the present invention;

FIG. 6 is a top perspective view of a second built-up core spacer in accordance with the teachings of the present invention;

FIG. 7 is a lateral cross-sectional view taken along line 7-7 of FIG. 6;

FIG. 8 is a perspective view of a second preferred embodiment of the dental post and core system of the present invention;

FIG. 9 is a perspective view of a third preferred embodiment of the dental post and core system of the present invention;

FIGS. 10A-10I show various embodiments for a dental post and core system wherein at least one or more of the fibers constituting the post are non-axially aligned with respect to axis A-A extending from the coronal end to the apical end of a root of a tooth;

FIG. 11 is a perspective view in partial section of an alternate embodiment for a flexible inelastic post with a plurality of randomly dispersed particles within a binder;

FIG. 12 is a perspective view of a portion of the flexible post of another embodiment for the present invention;

FIG. 12A is a side elevational view of a portion of the post as in FIG. 12;

FIG. 12B is a top plan view in cross section of the post as in FIG. 12, taken along line 12B-12B of FIG. 12A;

FIG. 13 is a perspective view of another embodiment including a group of fibers therein, for use in making a flexible post;

FIG. 13A is a side elevational view of the portion of the fiber as in FIG. 13;

FIG. 13B is a top plan view in cross section of the post as in FIG. 13, taken along line 13B-13B of FIG. 13A;

FIG. 13C is a close up perspective view of one fiber used in the embodiment shown in FIG. 13;

FIG. 13D is a close-up perspective view of the embodiment shown in FIG. 13, shown with an optional axially extending facet.

FIG. 13E is a cross sectional plan view of the embodiment shown in FIG. 13D.

FIG. 14 is yet another embodiment for a flexible post;

FIG. 14A is a top plan view of the post in FIG. 14, taken along line 14A-14A of FIG. 14;

FIGS. 15-15D show an alternate embodiment for a dental reconstructive pin;

FIG. 16A is a close-up perspective view of the embodiment shown in FIG. 13D with a single central wire;

FIG. 16B is a cross sectional plan view of the embodiment shown in FIG. 16A;

FIG. 17 is a top view of a cuspid tooth showing the outline of an oblong canal;

FIG. 17A is a top view of a cuspid tooth with the crown removed and two posts filling the oblong canal; and

FIG. 17B is a sagital view of a cuspid tooth with the crown removed and two posts in the oblong canal.

FIG. 18 is a perspective view of a top portion of a flexible post;

FIG. 19 is a perspective view of an application method of an apex sealing material;

FIG. 20 is a side elevation of a hand held electric heater in use;

FIG. 21 is a side elevation of an ultrasonic heater in use;

FIG. 22 is a top view of a flexible post with conductive jacket;

FIG. 23 is a side elevation of a microwave heater in use;

FIG. 24 is a side view of an optical heater in use;

FIG. 25 is a perspective view of an alternate embodiment for an endodontic post with a central cluster of flexible fibers leading to a flexible tip;

FIG. 26 is a perspective view of a further alternate embodiment for an endodontic post with a tapered tip which wraps around the body of the post;

FIG. 26A is a close-up detail view of a circumferential detent connection for the tapered tip as in FIG. 26;

FIG. 26B is a close-up detail view of a press fit connection for the tapered tip as in FIG. 26;

FIG. 26C is a further embodiment where a tangible sealing material aggregate is held in place by one or more short barbs;

FIG. 27 is a perspective view of a hand held instrument for holding a post of the present invention while applying heat or energy thereto;

FIG. 28 is a perspective view of a hand held heater for applying heat to an endodontic post with a malleable tip;

FIG. 29 is a perspective view of a small oven for applying heat or energy to an endodontic post with a malleable tip;

FIG. 30 is a further alternate embodiment for a pre-packaged, one-step curable post in which the entire post is made of a malleable material and sealed in a package before use, in standard post shapes, wherein the fibers of the post are set in the resin, epoxy or other suitable matrix material, which is either partially set in a gel or semi-solid state; and,

FIG. 31 is a further alternate embodiment for a post having a tapered tip of a sealer attached thereto.

### DETAILED DESCRIPTION OF THE INVENTION

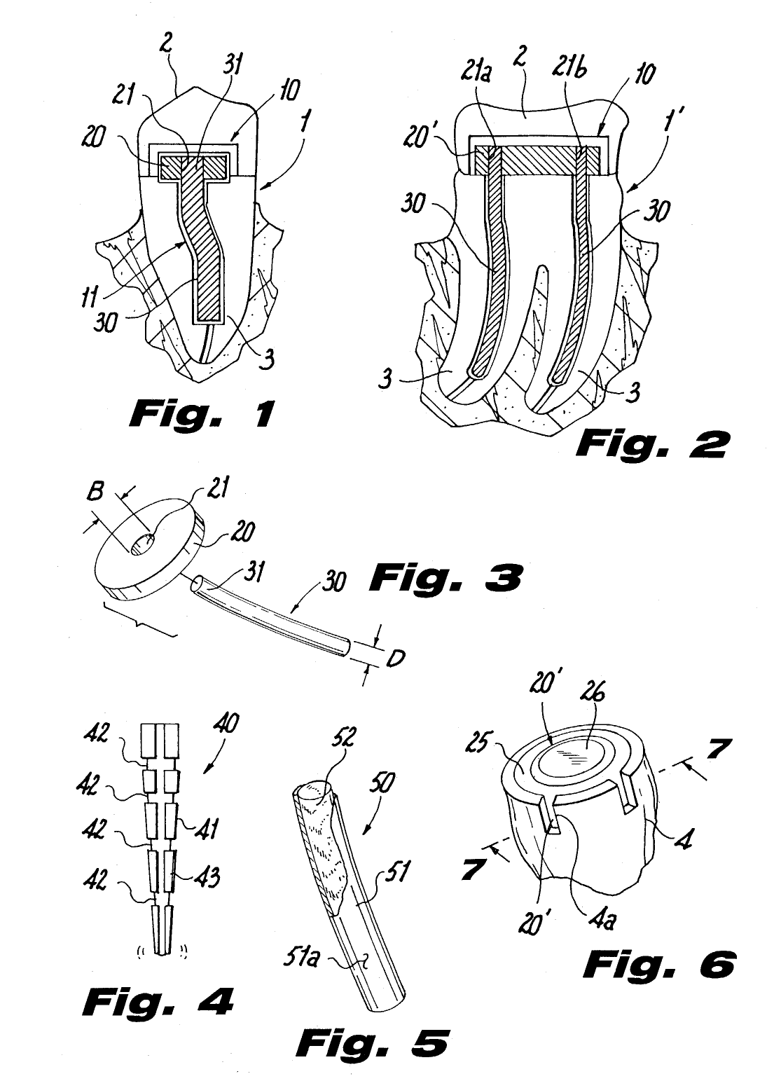

FIG. 1 illustrates a lateral cross-sectional view a first preferred embodiment of the dental post and core system 1 of the present invention. First system 1 generally comprises a core 10 and flexible post 11. Post 11 includes a core spacer 20 and a flexible inelastic post reinforcing rod 30 extending apically from the core spacer 20. The post reinforcing rod 30 may be cylindrical or tapered. Further, core spacer 20 may be flexible and/or resilient. In the first dental post and core system 1, core spacer 20 and reinforcing rod 30 are shown to be separately constructed. A bore 21 in core spacer 20 selectively engages an upper portion 31 of post reinforcing rod 30. However, core spacer 20 and reinforcing rod 30 may be integrally formed without departing from the spirit and scope of the present invention. The separable construction of core spacer 20 and the reinforcing rod 30 permits fabrication of built-up post and core systems 1 in a variety of configurations from readily identifiable components.

Core 10 is seated on the core spacer 20 and a crown 2, for example, is placed over the core 10 as known in the art.

The teachings of the present invention may be utilized for restoration of multi-rooted teeth having two, three or four diverging canals. In the second dental post and core system 1′ for a double-rooted tooth illustrated in FIG. 2 it can be seen that said second system 1′ includes a second core spacer 20′ having two bores 21a, 21b which engage respective flexible post reinforcing rods 30.

The advantages of a flexible post 11 in a dental post and core system are numerous. Firstly, a flexible post 11 can follow the contours of the root canal 3. This method of placement eliminates or reduces the amount of drilling required for root canal therapy and for preparation of the canal access. The reinforcing rods 30 can be appropriately sized to permit use of commonly-used dental drills. More intact tooth is left in place which has been shown to provide the best resistance to tooth fracture. The flexible post reinforcing rod 30 of the present invention also eliminates stress concentrations in the canal wall and dentin due to the apical lateral movement of rigid posts. Utilizing a flexible post 11 the intracanal stress at the apical level is shifted coronally to the area of maximum stress. The core spacer 20 absorbs the intracanal stresses by deformation of the body of the core spacer 20. Core spacer 20 therefore can be seen to serve as both a seat for the core 10 and as a stress absorber. A flexible post 11 also reaches further apically which provides greater retention. This is specifically applicable to the restoration of teeth that have suffered extreme loss of tooth structure where to gain adequate retention the length of the post must enter the curved portion of the root canal 3.

In the first preferred embodiment of the flexible post 11 in the first dental post and core system 1 of the present invention, illustrated in an exploded, perspective view in FIG. 3, the core spacer 20 and the flexible post reinforcing rod 30 are formed from identical material. This, however, should not be understood to be a limitation of the present invention. The core spacer 20 may be formed of a first material to optimize its stress resistance characteristics, reinforcing rod 30 may be formed of a second material to optimize its retention characteristics.

Core spacer 20 and post reinforcing rod 30 are preferably formed from reinforced plastics such as medical grade optical fibers, or fiberglass polyester composites similar to those used in the construction of fishing poles, flexible ceramic resin composites, graphites, teflons, polycarbonates and the like. Metals, such as pure or alloyed titanium, steel, platinum, palladium and the like, can be processed into fibers and bound in a matrix of resin or other binders for fabrication of the core spacer 20 and post reinforcing rod 30. The flexibility of these materials is close to the flexibility of the natural tooth and therefore will reduce the flexibility differential of the intact tooth and the inserted post 11. Fiberglass polyester composites and the like are also well suited for in-office etching of the surfaces of the core spacer 20 and reinforcing rod 30 for better and stronger cementation. Reinforcing rod 30 may also be treated with dental adhesives and bonding agents such as silane urethane, bisGma and acrylic resins to increase retention. Core spacer 20 and post reinforcing rod 30 also preferably include an appropriate amount of radio-opaque material such as titanium oxide, barium sulfate and other materials known in the dental industry to insure X-ray documentation.

The first preferred embodiment of the flexible post 11 is preferably color coded for identification purposes. In the first preferred flexible post 11, the core spacer 20 and reinforcing rod 30 are color identified according to the inside diameter of the bore 21 in core spacer 20, identified in FIG. 3 by the letter “B”, and the outside diameter of the reinforcing rod 30, identified in FIG. 3 by the letter “D”. In the preferred embodiment the reinforcing rods 30 are formed having the following diameters “D”: 0.036 inch, 0.040 inch, 0.050 inch, 0.060 inch, and 0.070 inch. The bores 21 of the respective core spacers 20 have a corresponding bore diameter “B” (marginally larger than rod diameter “D”) for snug engagement of the spacer 20 to an upper portion 31 of the post reinforcing rod 30. Bright colors are preferably used. The following color protocol is preferred:

| “B”, “D” | Color |
|---|---|
| .036 inch | White |
| .040 inch | Yellow |
| .050 inch | Red |
| .060 inch | Blue |
| .070 inch | Green |

A second dental post and core system 2 for multi-rooted teeth, as illustrated in FIG. 2, may have a second core spacer 20, wherein the respective first and second bores 21a, 21b are sized differently for placement of reinforcing rods 30 of different size. Prefabricated multiple root dental post and core systems 2 having differently sized reinforcing rods 30 will be multicolored in accordance with the above protocol. For example, a second core spacer 20′ may have a yellow ring around first bore 21a and a white ring around second bore 21b to indicate that this core spacer 20′ is to be utilized with a 0.040 inch reinforcing rod 30 in first bore 21a and a 0.036 inch reinforcing rod 30 in second bore 21b.

FIG. 4 illustrates in a front plan view a second preferred embodiment of a reinforcing rod 40 constructed in accordance with the teachings of the present invention. Second reinforcing rod 40 is a tapered, having flexible elongated member 41. The outer wall of the elongated member 41 includes a plurality of displaced circumferential serrations 42 and a channel 43 extending longitudinally between the respective serrations 42. The combination of flexibility in the second reinforcing rod 40 and the displacement of the respective serrations 42 is believed to reduce the wedging effect of rigid posts as known in the art.

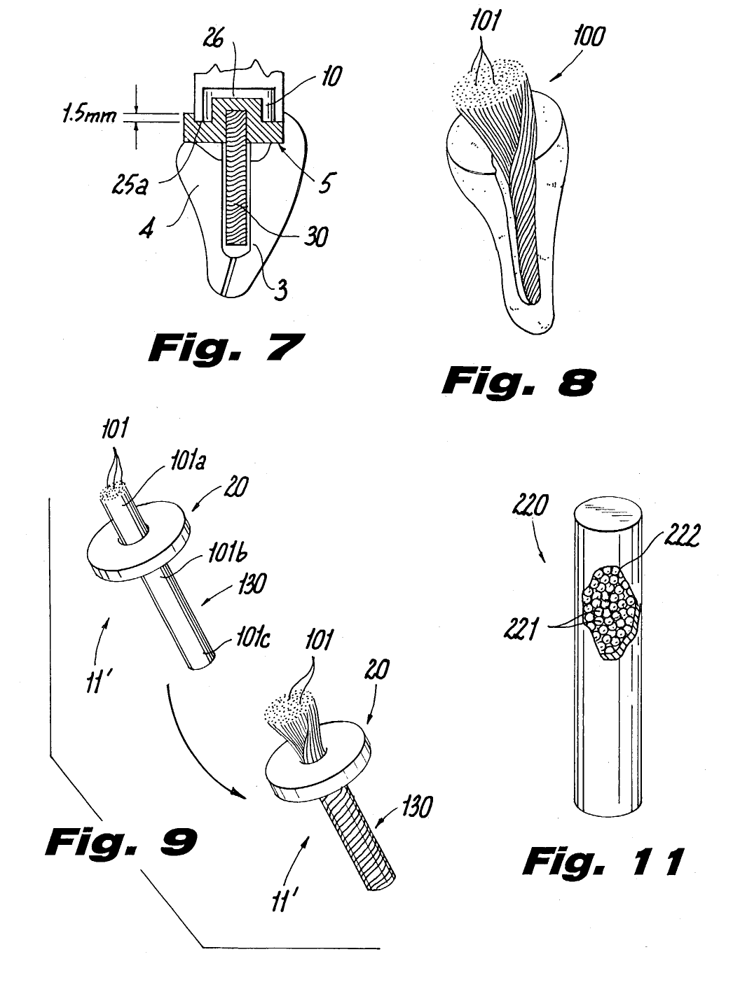

A third preferred embodiment of a reinforcing rod 50 is illustrated in FIG. 5. Third reinforcing rod 50 comprises a closed flexible sheath 51 having a compressible gel 52 disposed within the interior of the sheath 51. During placement of the third reinforcing rod 50 the wall 51a of the sheath 51 deforms to the varying diameter and curvature of the root canal.

From the foregoing, it should be readily understood that the respective first, second and third reinforcing rods 30, 40 and 50 may be utilized in conjunction with a core spacer 20 or a prefabricated or built-up core 10 may be attached directly to the coronal end of the reinforcing rod 30, 40, 50. A prefabricated core 10 for attachment directly to a reinforcing rod 20, 40, 50 may include a bore 21 extending therethrough as illustrated for the core spacer 20 of the present invention. Reinforcing rods 30, 40 find 50 may be pre-cut or formed in an extended length to provide a margin of safety for mistakes in measuring.

The core spacer 20 of the present invention may be prefabricated in standard sizes or built-up in the dentist's office. The external shape of core spacer 20 generally corresponds to the concavity of the chamber termed in root canal therapy. In teeth with a shallow concavity, standard dental drills may be used to machine a countersunk region 5 in the tooth (FIG. 7) for receipt of core spacer 20 or a built-up core spacer 20′. FIGS. 6 and 7 illustrate a preferred embodiment of a built-up core spacer 20, constructed in accordance with the teachings of the present invention. The flexible reinforcing rod 30 is placed into the root canal 3 (FIG. 7). Built-up core spacer 20′ is then formed about the coronal end of first reinforcing rod 30 by injection of any of the suitable fast-setting liquids or pastes known in the art. Built-up core spacer 20′ initially extends to the top of the tooth dentin 4 and into any fractures 4a or the like in the tooth. A recessed ring 25 is then countersunk into the top of the built-up core spacer 20′ along the inside edge of the tooth to form a central, raised portion 26 of the built-up core spacer 20′. It is preferred that the floor 25a of the recessed ring 25 is approximately 1.5 mm below the top of the tooth dentin 4. As can be seen in the cross-sectional view of the built-up core spacer 20′ illustrated in FIG. 8, a core 10 is seated onto the top of the central, raised portion 26 and the floor 25a of the recessed ring 25. Preferably, sufficient lateral space is left so that the crown 2 may be fitted over the core 10 to likewise rest on the floor 25a of the recessed ring 25 approximately 1.5 mm below the top of the tooth.

A mutable flexible post 100 is illustrated in FIG. 8 and a mutable post reinforcing rod 130 is illustrated in FIG. 9. Mutable post 100 and mutable post reinforcing rod 130 are preferably formed from a bundle of reinforced plastic or other fibers 101 cemented together at the central portion 010b and the lower portion 101c of the fibers 101. The upper portion 101a of the fibers 101 is loosely compacted so that the upper portion 101a may be selectively flared to provide additional surface area to scaffold a built-up core. Flaring of the upper portion 101a of the fibers 101 may be performed at the factory or in the dentist's office using standard crimping pliers. A prefabricated core (not shown) may be attached to the coronal aspect of the mutable post 100 when it is disposed in its unflared position.

As shown in FIG. 9 the mutable reinforcing rod 130 constructed in accordance with the teachings of the present invention may likewise be utilized in a flared or unflared position. A first core spacer 20 is attached to the coronal end of the mutable reinforcing rod 130. The mutable post 11′ comprising a first core spacer 20 and a mutable reinforcing rod 130 may be used to support a prefabricated core, or the coronal end of the mutable post 11′ may be flared to form a scaffold for a built-up core. An advantage of this preferred embodiment of the present invention is that a single construction can be used for either a prefabricated dental post and core system or a mutable post reinforcing rod 130 to support a built-up core.

Post 11 may be made without core spacer 20. Moreover, post 11 may be made from a material having a plurality of distributed fibers, such as medical grade optical fibers, wherein at least one of the fibers extends non-axially aligned with respect to a straight axis extending from the apical end to the opposite coronal end of a root of a tooth. For example, the fibers of post 11 may be a bundle of fibers, a longitudinally twisted bundle, a twisted braid, a woven lattice, a helically wrapped bundle of fibers, or a composite of randomly dispersed fibers in a binder.

In the preferred embodiment, at least one of the fibers of post 11 extends non-axially aligned with respect to the straight axis of a root of a tooth.

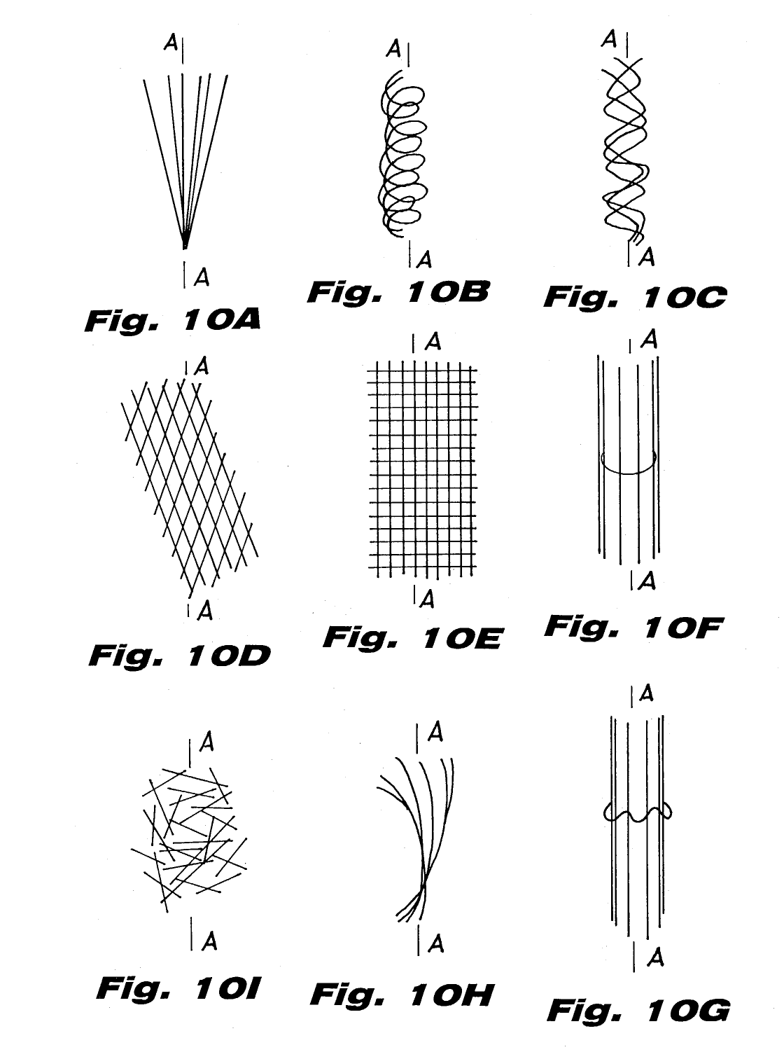

For example, in a bundle of fibers, such as the conical bundle of fibers shown in FIG. 10A, while some of the fibers may extend parallel to the straight axis A-A of the root, at least one or more of the fibers extend in a non-axial direction which is not parallel to straight axis A-A of a root of a tooth. That is, at least one or more of the fibers extends in a transverse or angled direction away from the straight axis A-A of the root of a tooth.

With respect to a longitudinally twisted bundle, such as shown in FIG. 10H, a twisted braid, such as shown in FIG. 10C, a helically wrapped bundle of fibers, such as shown in FIG. 10B, the twisting or helical wrap of the fibers causes many, but not necessarily all, of the fibers to extend non-axially. Concerning a woven lattice of fibers, such as shown in FIGS. 10D or 10E, while one set of fibers could extend axially parallel to the straight axis A-A of the root, the other intersecting set of fibers extends in a direction which is non-axially aligned with respect to the straight axis A-A of the root. Moreover, as shown in FIG. 10G, even if most of the weft of a weave of a plurality of fibers extends parallel to the straight axis A-A of the root, at least one or more fibers constituting the warp of the weave of fibers extends non-axially with respect to the straight axis of the root of the tooth. Furthermore, as shown in FIG. 10F, instead of a true weave, a bundle of axially aligned fibers may have at least one or more non-axially aligned fibers constituting a strap collar containing the remaining fibers (whether axially aligned or not) therein.

While the bundles of fibers shown in FIGS. 10A-10I are shown without core spacers, such as core spacer 20 in FIG. 1, similar core spacers may alternately be provided, or the ends of the bundles of fibers may be flared, such as shown in the conical bundle in FIG. 10A or the twisted bundle shown in FIG. 10H.

As shown in FIG. 10I, concerning a composite of randomly dispersed fibers, there is always the possibility of one or more of the fibers being axially aligned to the straight axis A-A of the root of a tooth. However, in order to be randomly dispersed, at least one or more of the fibers extends non-axially with respect to the straight axis A-A of the root of a tooth.

The fibers in FIGS. 10A-10I may be formed from metal or non-metallic fibers in a composite, such as within a plastic material. Alternately, the coronal end may be flared by loose compacting of the coronal end, or by mechanical undercutting of the coronal end.

In addition, the post is both flexible and inelastic, so that the post can bend but generally maintain its original length. For example, in flexing, one side is extended, and the other side is compressing about an axis.

FIG. 11 is a perspective view in partial section of a further alternate embodiment for a flexible inelastic post 220 with a plurality of randomly dispersed particles 221, such as beads or other shaped particles, within a binder 222.

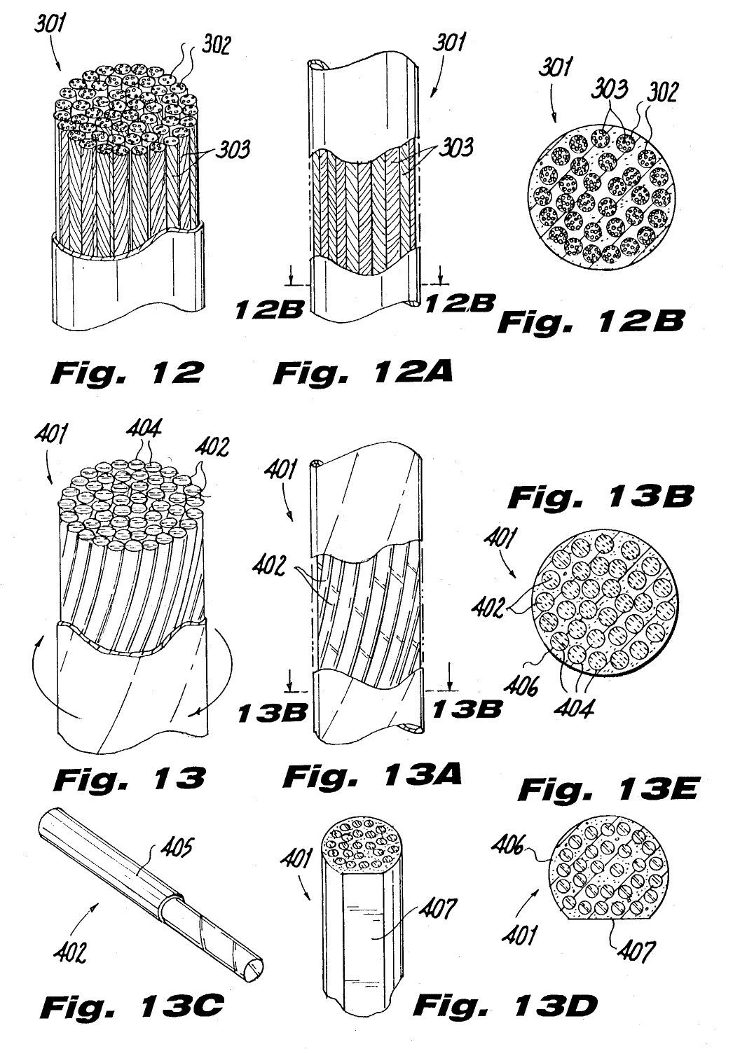

As shown in FIGS. 12-14, an endodontic post 301 for root canal therapy has a modulus of elasticity which is less than or equal to that of tooth dentin, thus reducing the risk of fracture of the post. In the embodiment shown in FIGS. 12, 12A and 12B, post 301 preferably includes optical fiber filaments 302 making up fiber bundles 303, in a twisted bundle of the linearly extending fiber bundles 303.

Optionally, fibers 302 may be other fiberglass fibers.

The purpose of the slow twist or other geometric arrangement in the bundle of the fibers 303, is to reduce fracture lines in the dental posts that could develop from shaving or adjusting the post size by removing axial orientation of the fibers 303 in one direction, such as in the aforementioned C-POST® of Bisco.

Filaments 302 of fibers 303 may be fiber optic fibers in cables which are normally used in the human body for endoscopic visual examination of internal organs through a tube through which the fibers extend.

In another embodiment shown in FIGS. 13, 13A, 13B and 13C, instead of a group of filaments 302 forming a fiber 303, in this preferred embodiment, post 401 is made of a generally cylindrical bundle of optical fibers 402 which are twisted when bundled together and wrapped within a resin 406.

Optionally, fibers 402 may be other fiberglass fibers.

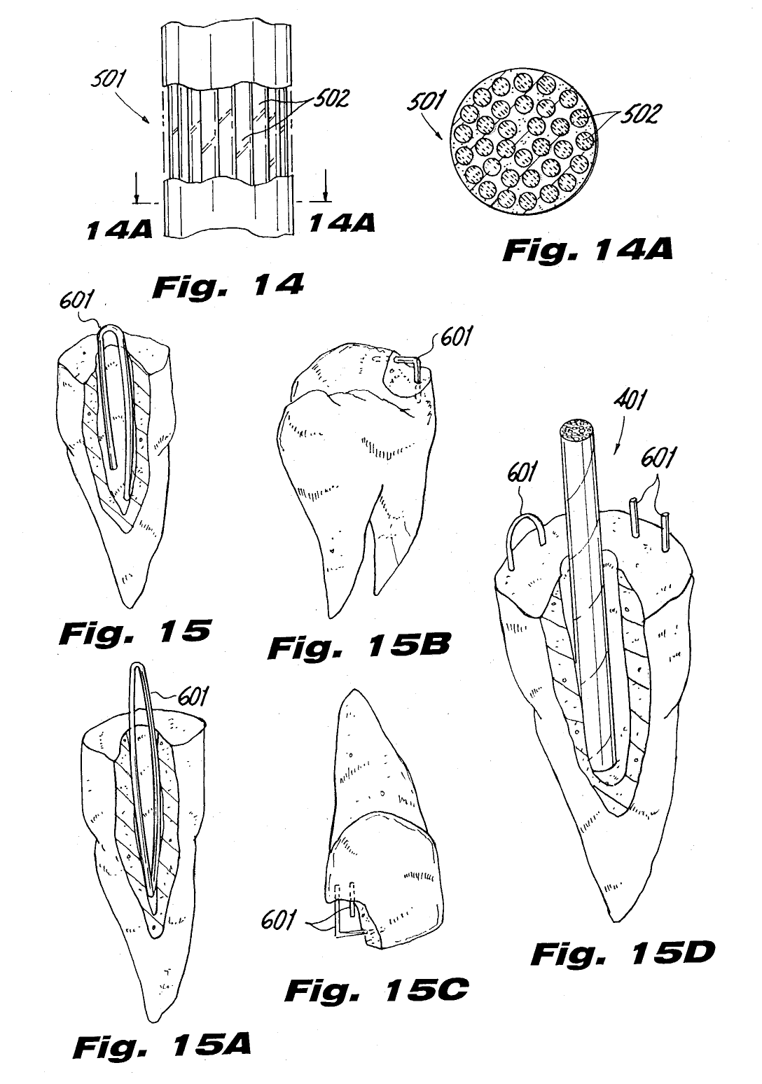

In yet a further embodiment shown in FIGS. 14 and 14A, fibers 502 are generally axially aligned.

As shown in FIG. 13C in the preferable version, the fibers 402 are silica base fibers having a pure silica core 404 of SiO₂. An example of the silica based fibers is from Polymicro Technologies Inc. of Phoenix, Ariz.

The coating 405 is a coating of a plastic polymer. The coating 405 can optionally be made to leak light therethrough by etching or scoring, so that it can pull light out transversally through the edge of the root. This is beneficial when using a light sensitive adhesive which reacts to light. The light activating dental cement in the root adjacent to the posts may be a bonding light cement, such as light activating dental cements include chemical resin such as SCOTCH BOND® of 3M Corporation of Saint Paul, Minn.

In this embodiment, the silica core 404 is coated with coating 405, such as KYNAR® brand PVDF (polyvinylidene fluoride), which meets USP class VI pharmaceutical standards. KYNAR® (polyvinylidene fluoride) is a fluoro-polymer which is strong, as reflected by its tensile properties and impact strength, and it has excellent resistance to fatigue. According to ASTM test D638, it has tensile strength of 5,000 to 6,500 psi yield. They have a tensile modulus according to ASTM test D882 of 150 to 200×10³ psi. Moreover the crystalline state of the KYNAR® (polyvinylidene fluoride) resins can be modified in rapid cooling to promote smaller crystalline size with increased crystallinity of their higher values for yield strengths than modulus and hardness.

Other resins, such as vinyl esters, acrylates or other polymer plastics may work as well as KYNAR® (polyvinylidene fluoride) brand resin, with different FDA ratings.

Based on the following calculations, while the diameter of each fiber 402 may vary, for a post having a diameter of about 0.040 inches, each fiber 402 is preferably about 60 microns in diameter. In that case, post 401 has about 215 fibers 402 in a post 401 having a diameter of 0.04. For a post 401 having a diameter of 0.050 inches, each fiber 402 is also preferably 60 microns in diameter. Therefore, post 401, with a diameter of 0.05 inches, has about 336 fibers 402.

However, the diameter of fibers 402 can be reduced or enlarged, thus increasing or decreasing the number of fibers 402 within a cross sectional area of post 401.

As noted, the diameter of post 401 will be about 0.05 inch, being made up with a plurality of fibers 402 plus the saturation of an epoxy binder 406 surrounding fibers 402. Epoxy resin 406 may have an optional colorant/opaquer mixed into the epoxy resin.

A preferred embodiment for an epoxy resin is the MASTER BOND® Polymer System EP21LV of Master Bond, Inc. of Hackensack, N.J. MASTER BOND® is a two component, low viscosity epoxy resin in which the fibers are cast. The rigidity of MASTER BOND® can be adjusted by adjusting the mix ratio of the two components.

The number of fibers 402 can be reduced, as long as the amount of epoxy resin binder 406 is altered, to increase or decrease the flexibility of the post 401, with a concomitant increase or decrease of the number of fibers.

For optical fibers 402 of about 60 microns, the radius is about 30 microns and the area of each optical fiber is 900×3.14=28.27 sq. microns. If one uses “n” to equal the number of optical fibers 402, then n×28.27 is the total area of all the 60 micron filaments in the group (when one is looking at a cross section of post 401). These dimensions are applicable even if posts 401 are twisted or braided, etc.

The total area of a 0.05 inch diameter post in cross section in sq. microns becomes:

0.05×25.4=1.27 millimeters−1270 microns diameter, which includes a 635 micron radius. Therefore where radius=R\hat{ } 3.14×635×635=1.27×10⁶. sq. microns. Therefore, the amount of epoxy and opaquer needed to surround all the optical fibers 402 in post 401=pi(R\hat{ }×R\hat{ })−pi(R*×R*)n. The “pi” can be factored out.

Accordingly, as the R* increases in value and the R\hat{ } remains constant, there will be less epoxy/opaquer mixture in the interfilament spaces.

One way to increase the epoxy/opaquer mixture would be to increase the value of R\hat{ } in relation to the R*.

Using this relation, one could adjust the mechanical and optical properties of the posts and pins. Accordingly, there are epoxies on the market whose modulus of flexibility can be altered by simply changing the ratio of fibers 402 to epoxy resin 406.

Another factor to be considered is creating an outer skin of epoxy surrounding post 401 of any embodiment, is that epoxy resin 406 be left clear to transmit light. This dimension=pi(R\hat{ }×R\hat{ })−pi (R\hat{ }−z)×(R\hat{ }−z), where R\hat{ } is the radius of the entire post 402, including the skin coat “z” represents the thickness of the skin coat.

Preferably the post 401 of the bundle of fibers 402 includes a rounded end, and post 401 may optionally be polished at one end to direct light axially therethrough. Post 401 may also have a taper.

As shown in FIGS. 13D and 13E, post 401 may be provided with an optional continuous groove or facet 407 of about 50 to 100 micron in depth to increase surface texturing and to counteract rotation of post 401 within a tooth canal.

The standard length of the post 401 is ⅝ inch and the standard diameter is 0.04 inch to 0.05 inch with an optional taper at the top with ⅛ inch linearly. The texturing may be by sand blasting or by die drawn surface cut, such as at least one groove or facet 407, across linearly or axially of about 50 to 100 micron depth or it may be etched with acid or laser lights such as carbon dioxide laser or Yag laser or there may be an outer skin sheath added which is texturized. Preferably, the individual fibers 402 in one post 401 in bundles are twisted as they come off a spool.

As shown in FIG. 15, another use for which the posts may be used for is as a dental cavity pin 601 to replace titanium, steel, or gold pins which tend to corrode and which do not have a good modulus of elasticity. Optionally the pin 601 may be tooth colored by adding barium sulfate to the epoxy resin that holds the bundle of fibers together, such as in a medical grade epoxy such as bisGMA. The optional pin 601 for teeth with large areas of decay or traumatic damage may be reconstructed, using pins 601 as a lattice scaffolding to stabilize the filling. The flexible pin 601 of the present invention can be looped around and closed into the pin wherein the canal is back filled with composite material. The looping helps with retention by exerting a lateral force against the inside of the canal to provide an anti-rotational feature for the pin 601, if an axially extending surface facet is cut. Other possible uses of pin 601 is for hip prosthesis, or other bone implants or pinned fractures to reduce resorption bone dissolution due to stress or infections. Alternative coatings of pins 601, such as titanium oxide, into the epoxy resin, to facilitate biochemical bonding of the pin 601 to bone.

The flexible posts of the present invention also leads to improved methods of endodontia that eliminate drilling for post placement.

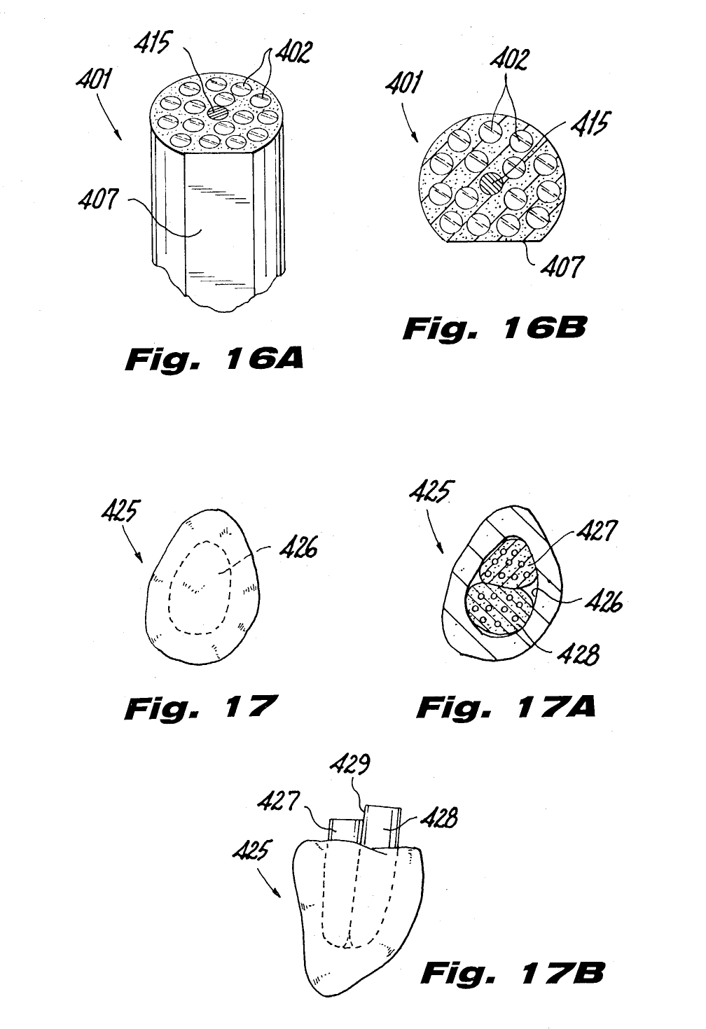

FIGS. 16A and 16B show the substitution of a single wire 415 for one of the fibers 402. The use of one or more metal wires renders the post 401 radiopaque. The wire 415 may be alloyed titanium, steel, platinum, palladium or the like. By placing the wire 415 at or near the center, it can be pulled out to facilitate removal of the post. Typically 0.004″ in diameter, the wire (once removed) would leave a pilot hole for guidance of a reamer that can be used to remove the post

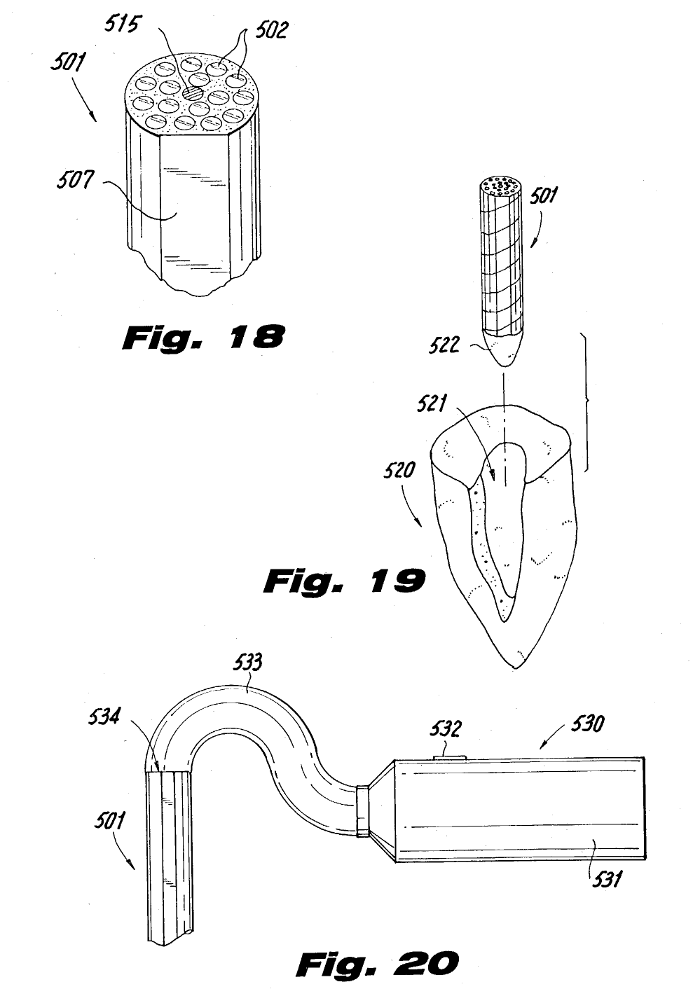

FIG. 17 shows a top view of a cuspid tooth 425 with the outline of an oblong canal 426. Such an oblong shape is difficult to fill adequately with a standard post. Other shapes with irregularities may be difficult to fill as well with a single post. FIG. 17A shows the same tooth 425 with the crown removed and two faceted posts, 427 and 428, almost completely filling area 426 as defined by the oblong canal. FIG. 17B shows a sagital view of this arrangement illustrating the good fit that can be achieved with two posts with facets 429 butted together to lock them in an anti-rotation configuration. By matching two or more faceted standard sized posts, many different sized and shaped tooth canals can be optimally accommodated.

The embodiments of this invention shown in FIGS. 18-30 relate to the application of sealing material, such as a resin, plastic, composite, coated plastic or gutta percha, by pre-attachment to the end of a post as used in dental root canal therapy. In this method, the post is inserted in the root canal cavity and energy is applied after the post is inserted to plasticize and condense the tangible sealing material aggregate.

Alternatively, the post with the gutta percha or other sealer may also be placed in the root canal and may be held in place by root canal cement, which can be adhesive or non-adhesive, without the use of heat or condensation, as an uncondensed single point fill. The sealing material described above does not hold the post in place, but generally seals the natural apex at the bottom of the tooth root. The post is held in place with cement which can be distinctly different from the sealing material, or can alternately be a resin or glass ionomer cement which acts as both an adhesive and a sealer.

The embodiments of FIGS. 18-31 address individual custom shapes of a patient's root canal, on a per patient basis, created from preformed, standard sizes. The embodiments shown in FIGS. 18-31 can be pre-formed to standard sizes common to the endodontic industry. The ends of the posts 501 of FIGS. 18-24, as well as posts 601 and 701 of FIGS. 25-29, are malleable to negotiate the deep apical end of a tooth root canal. The malleable materials of the apical portions of the posts 501, 601 and 701 allow bonding of the post intimately to the root canal. Therefore, the posts 501,601 and 701 seal the apical end of the root canal of the patient being treated.

It is further noted that FIGS. 18-24 show embodiments where heat, energy or a chemical reaction is applied to the post for curing sealing material in an intra canal basis, after the post with malleable material has been inserted within the root canal.

Moreover, FIGS. 25-29 show embodiments where the malleable apical end of the post is cured outside of the canal, before insertion into the root canal.

It is further noted that a combination of curing environments can also be used, where the malleable material of the post is first partially cured outside of the canal, before insertion, and final curing occurs when further heat or energy is applied to the malleable material of the post after it has been inserted into the canal.

FIG. 18 shows a top end detail of a flexible post 501 consisting of an array of non-metallic fibers 502 and an optional single metal wire 515 bundled together in a resin matrix.

Such a metal wire is also shown in FIGS. 16A and 16B herein, which is described as a metal wire 415 within non-metallic fibers 402, to provide a radiopaque member within non-metallic post 401. Besides providing for radiopaque images, wire 415 can also conduct heat or other energy, such as piezo-electric energy causing vibrational frequency, to soften malleable tangible sealing material aggregate 522 at the apical end of flexible post 501.

Post 501 also has an optional facet 507. Wire 515 can be a nickel-titanium alloy, steel, gold or other generally good heat conductor. These embodiments shown in FIGS. 18-24 also apply to rigid posts and flexible posts using metal fibers or carbon fibers.

More than one wire 515 can be used to enhance the heat conductivity of post 501.

FIG. 19 shows the general method of having a cone of tangible sealing material aggregate 522 such as gutta percha pre-attached to the distal (apical) end of post 501 for insertion, as a subassembly, into root canal cavity 521 of tooth 520. The tangible sealing material aggregate can have a bacteriostatic antibiotic or anti-inflammatory component that can be added to the tangible sealing material aggregate.

In the embodiment of FIG. 20, a hand-held electrically operated thermal heater 530 is used to apply heat to the top end of post 501 at the flat interface 534 of extended heat probe 533. Housing 531 contains batteries, which are applied to resistive heat probe 533 through switch 532. A heating unit similar to that described by Martin (U.S. Pat. No. 6,270,343), which is battery operated, can be used. Alternatively a wire-connected heating unit that is powered from AC mains can also be used. In any case, the heat conductive wire or wires 515 conduct the heat applied at the flat post top surface to the tangible sealing material aggregate 522 within root canal 521.

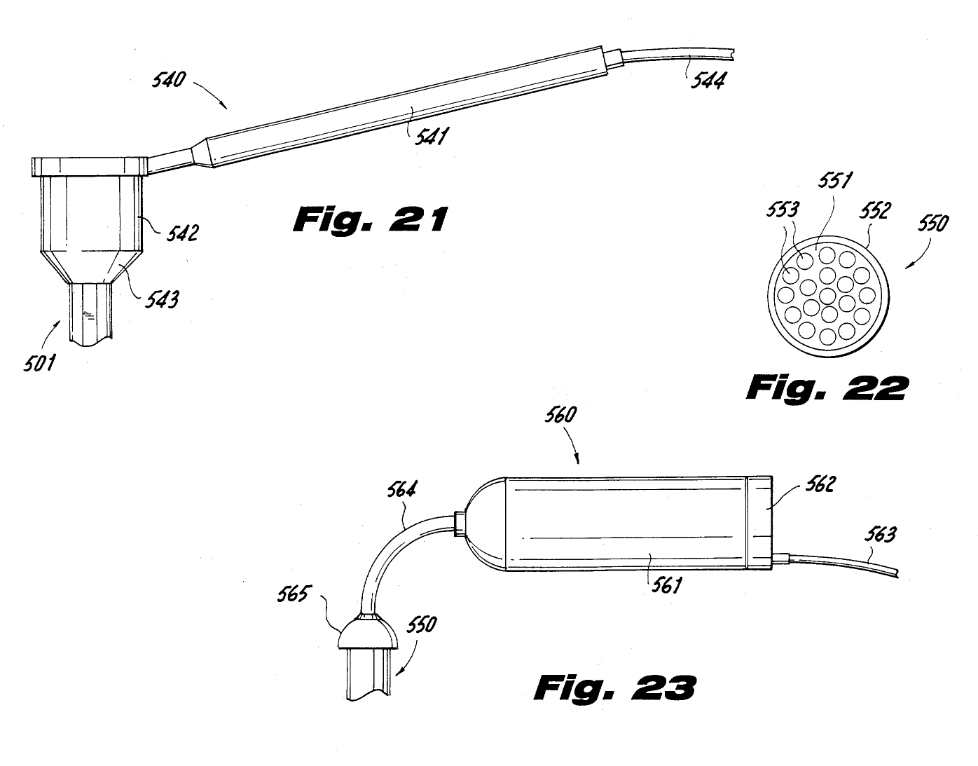

In the further embodiment shown in FIG. 21, heat generated by ultrasonic heating apparatus 540 is used. Cable 544 carries ultrasonic frequency alternating voltage through handpiece 541 to a piezoelectric stack in housing 542. Ultrasonic horn 543 couples this vibratory energy to the top surface of post 501. Some heat is generated at the interface with post 501 since the top of post 501 will deform somewhat at ultrasonic frequency. This is conducted downward by wire 515. Some heat is also generated at the interface between the distal end of post 501 and the tangible sealing material aggregate 522 which will absorb any of the transmitted ultrasonic energy conducted by post 501. Therefore, the sum of heat energy imparted by apparatus 540 at both interfaces is used to advantage to melt and condense tangible sealing material aggregate 522.

Another embodiment of FIG. 22 shows an end view of post 550 including a number of fibers 553 in a resin matrix 551. An electrically conductive coating 552, which may be a metallic plating or sputtering, surrounds the outer surface of post 550. Both fibers 553 and resin matrix 551 are good dielectric material of low loss. Therefore, post 550 can be construed to act as a microwave waveguide.

Microwave apparatus 560 of FIG. 23 (not unlike that of Seghatol, U.S. Pat. No. 6,254,389 B1) includes power cord 563 from a power supply, housing 561 containing the microwave generator, cooling fan 562, rigid waveguide 564, and coupling 565 which properly interfaces with post 550. Post 550 carries the microwave radiation to the distal end, where it is absorbed by the tangible sealing material aggregate 522, which is then heated to the proper temperature. Tangible sealing material aggregate 522 can be enhanced with additives which are microwave absorbent material such as metallic oxides or specialty ceramics. These tend to enhance heating and protect the patient from high levels of microwave energy. An alternative heating method using microwaves dispenses with the design of post 550 and use a post such as post 501 using a lossy dielectric resin matrix along with a single metal wire 515 (to minimize reflection). Microwave absorbent additives mixed into the resin matrix can enhance the effect. The microwaves can then be absorbed by post 501, thereby heating it. This heat is conducted by wire 515 to tangible sealing material aggregate 522.

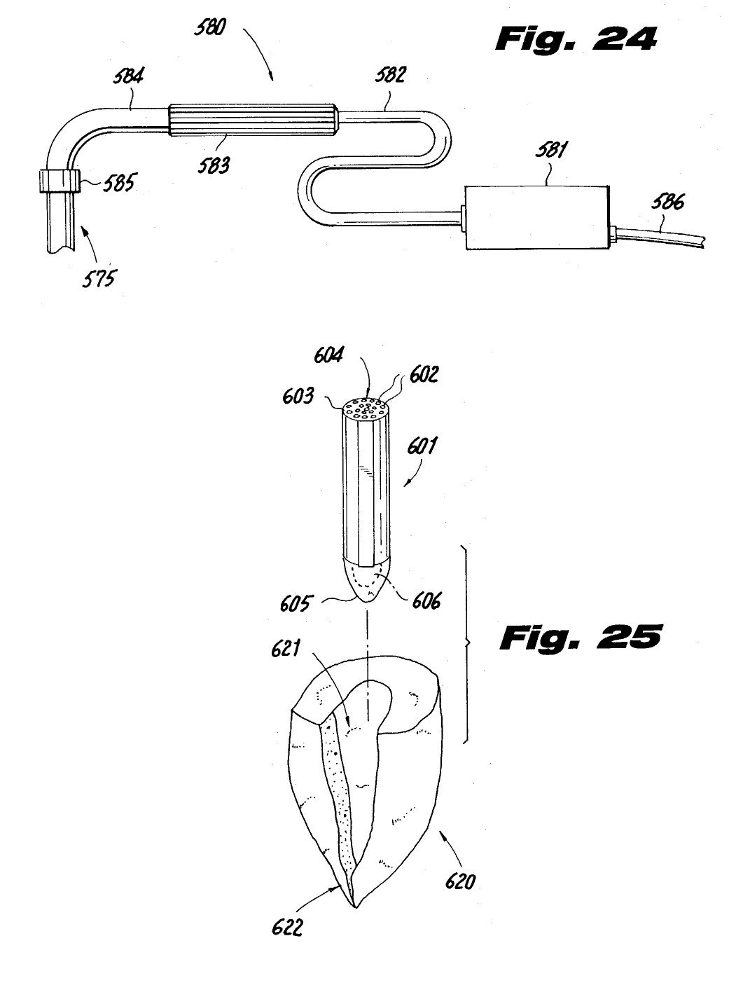

Another embodiment shown in FIG. 24 uses light energy to heat tangible sealing material aggregate 522 through flexible post 575 using optical fibers in construction. Light apparatus 580 includes electric supply cord 586 connected to light generating apparatus 581. The optical output is via fiber optic bundle 582, which passes through handpiece 583 and further through neck 584 and optical interface 585. In operation, light energy is conducted through post 575 by conduction through the fibers and resin of the post and impinges on tangible sealing material aggregate 522 which is consequently heated. Although a powerful halogen light source can be used (in housing 581), a controllable laser source is also effective.

FIG. 25 is an embodiment which is for an endodontic post 601 with fiberglass fibers 602 and resin 603 surrounding the inner, heat curable fibers 604 (or metal rods) which stick out through the bottom in a tapered end 605, like how a ball point pen cartridge sticks out of the hollow ball point pen barrel when the button is pushed down to extend the cartridge below the hollow barrel.

The central cluster of flexible fibers 604 in FIG. 25 goes all the way to the end of the post 601. They could be highly thermally conductive wires such as stainless steel while the surrounding fibers (shorter) could be semi-rigid such as E-glass. The post of FIG. 25 is assembled as a “pre-preg” or not final shape bundle that can be handled without separating.

If a thermoplastic approach is used, the fibers 604 are encased in a thermoplastic resin, which softens when heated so as to conform to the shape of the root canal.

FIG. 25 also provides an optional stop tip 606 at the end of the malleable end of fibers 604, to prevent incursion of the apical end thereof below the apex 622 of canal 621 of tooth 620. By the teaching of Applicants' prior U.S. Pat. No. 6,024,565, there is described an endodontic measuring system, which includes a plurality of user selectable elongated cylindrical and tapered diameter measuring rods having graded diameters known to the user for insertion as probes into an endodontic canal, wherein the diameter of the natural lower root tip aperture and length of the tooth canal from apical to coronal end are to be determined. Therefore, an exact sizing of the working length of root canal 621 to the apex 622 can be determined.

Another chemistry for curing involves the use of UV or visible light as a curing initiator.

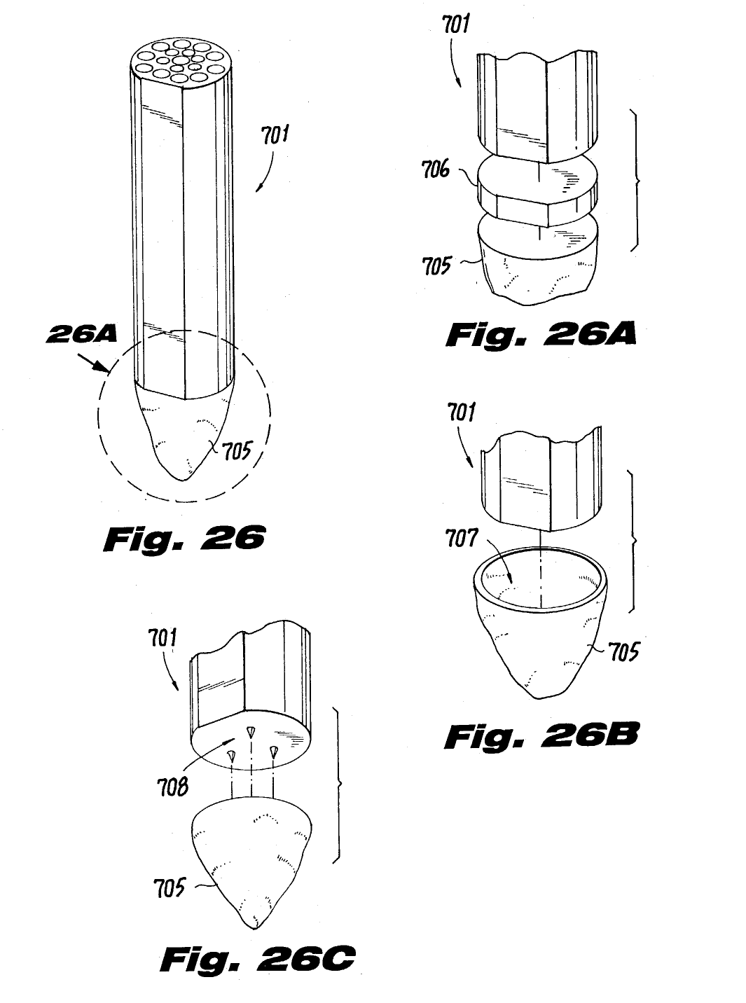

The same is true for the post 701 of FIGS. 26, 26A and 26B, which includes a wrap around tapered tip 705 as an uncondensed single point fill. In this alternate embodiment the malleable tapered tip 705 grips the outside of the fiberglass post 701. The gripping may be enhanced by a circumferential detent 706 or a press fit male-female connection, wherein the female cavity 707 is either in the filling, tangible sealing material aggregate or in the post itself. FIG. 26C shows a further embodiment where a tapered tangible sealing material aggregate tip 705 is held in place by one or more short barbs 708 at the distal end of post 701, as an uncondensed single point fill.

Posts 501, 601 and 701 can be provided in standard post shapes, such as cylindrical, tapered or parallel sided, serially stepped, serially notched, facetted, or combinations thereof.

The tips 605 and 705 of FIGS. 25 and 26 are malleable, and can mold in an omni-directional direction and follow the apical contours of the root canal of a tooth.

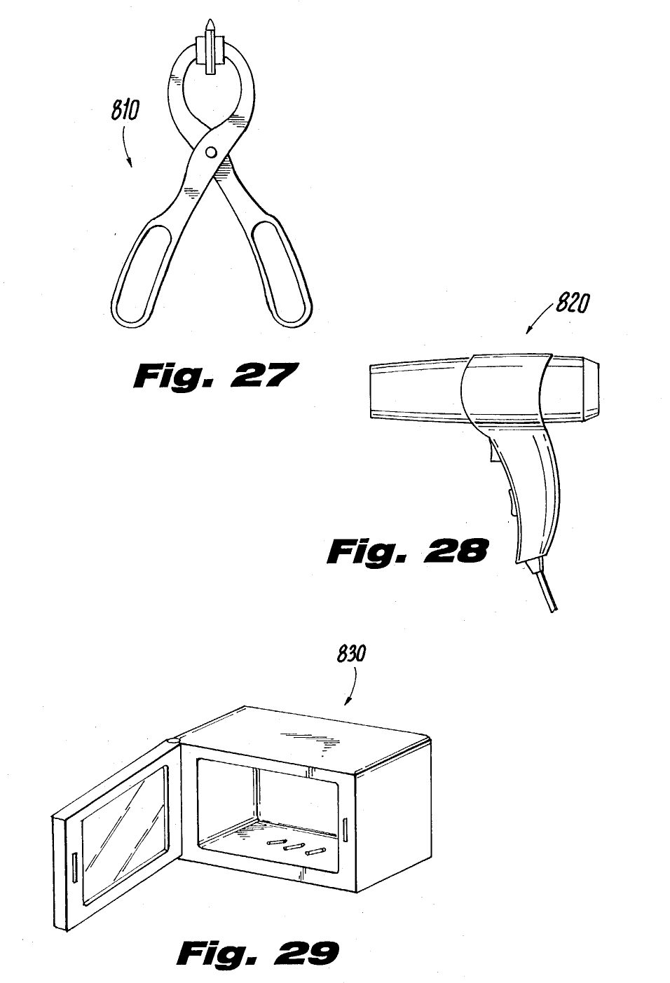

If a thermoplastic approach is used, the fibers are encased in a thermoplastic resin, which softens when heated. Posts 601 or 701 can be held by a holding instrument 810 as in FIG. 27 and heated before insertion into the root canal via a heat gun 820 as in FIG. 28 or placed in an oven 830 as in FIG. 29.

It is further noted that the heating of the malleable ends 605 and 705 of the endodontic posts 601 and 701 is enough to soften the malleable ends 605 and 705, but limited so as not to cause cellular damage to the surrounding tissues of the patient. Pre-preg materials are only used if they cure at temperatures that will not cause cellular damage or harm to body tissues (i.e. won't “burn”). This temperature limitation also applies to some formulations (such as types of two-part epoxies) which are exothermic during curing.

Pre pregs are convenient to use in prefabricated sizes and shapes, because they incorporate fibers and a matrix, such as resin, together in a flexible aggregate, that can be manipulated to conform to the necessary net shape prior to curing, without adversely separating the fibers from the matrix. Therefore, the aggregates 605 or 705 of FIGS. 25, 26, and 31 can be a filled or unfilled gel, resin or composite, located at the tips of posts 601, 701 or 901 of FIGS. 25, 26, and 31.

Additional heat can be added after insertion of posts 601 and 701 in the canals, by the instrument shown in FIG. 20.

Pre pregs can use a two-part epoxy that is partially cured. This is finished-cured by applying heat. An alternate pre preg embodiment involves the use of cyanoacrylate contained in micro-spheres or “balloons” which lyse when heat or moisture is applied. This can be done either before (if a slow reaction is needed) or after insertion in the root canal. A temporary porous matrix can be used to hold the endodontic post, the micro sphere balloons, and the post fibers together.

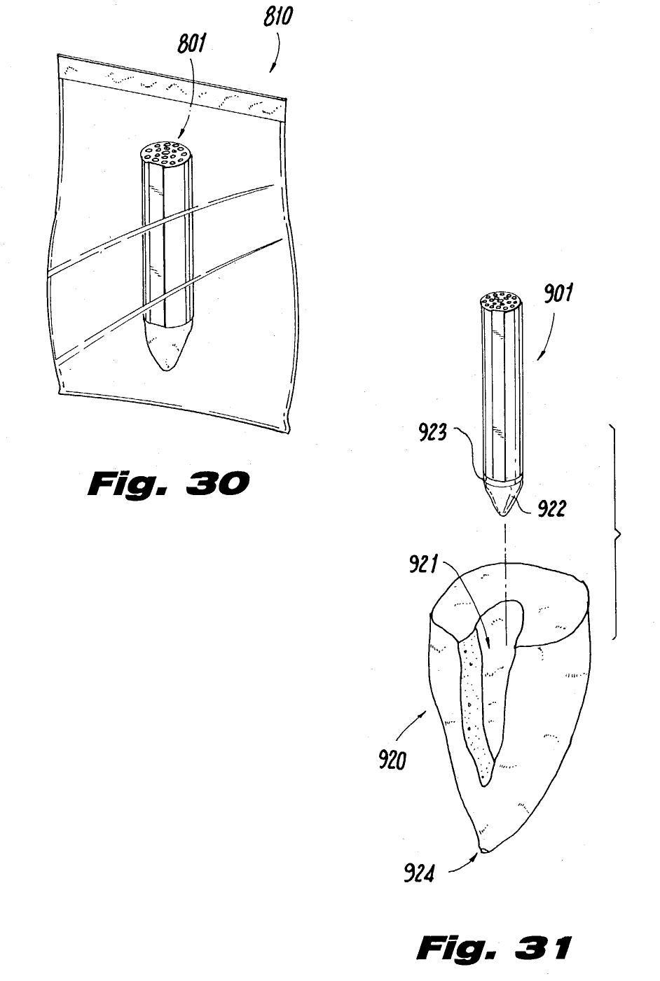

FIG. 30 is a further alternate embodiment for a pre-sized and pre-packaged post in which the entire prefabricated post is made of a malleable material, such as pre preg fiberglass, carbon, zirconium, particulate filler or combinations thereof, in standard post shapes, such as cylindrical, tapered or parallel sided, serially stepped, serially notched, facetted, or combinations thereof. The post 801 is provided in individually vacuum-sealed packages 810, which prevent the curing of post 801 before the package is opened for curing. The fibers of the post 801 are set in the resin, epoxy or other suitable matrix material, which is either partially set in a gel or semi-solid state. The resin in post 801 is first partially cured during manufacturing in a B-staging process, which permits the resin to stay within the fibers while packaged before use. The pre-preg post is inserted into the root canal, and is able to negotiate the curves of the root canal and seal the apical apex of the root canal. The matrix gel or liquid matrix can be set by heat, light, ultrasonic or chemical means, as shown in FIGS. 18-24, thereby bonding the post into the canal and sealing the apical apex all in one step.

FIG. 31 shows that the tapered sealer material tip 922 may be removably attached to post 901, and permanently attached as an uncondensed single point fill within canal 921 of tooth 920, by root canal cement to the root canal walls. In such a case tapered tangible sealing material aggregate tip 922 is removably attached by methods such as by a circumferential detent as in FIG. 26A, by a press fit connection as in FIG. 26B, or by one or more small barbs as in FIG. 26C. FIG. 31 also shows that endodontic post 901 preferably includes a stop 923 provided at an apical end of post 901, thereby preventing an apical end of post 901 from intruding beyond an apical end of the tooth root canal into periapical tissues below the tooth root canal. Stop 923 may be configured as a bottom end of post 901, in that it has a diameter greater than apical opening 924 at the bottom of root canal 921.

Moreover, the malleable end of the post 501 as in FIGS. 18-24, post 601 as in FIG. 25, post 701 in FIG. 26, post 801 of FIG. 30 and post 901 of FIG. 31 preferably have an “06” taper, which is the taper for conventional root canal files, i.e., having a taper that changes 0.06 mm for every lengthwise mm change of the tapered post. However, the taper can range from “04” to “08” depending upon the thinness or thickness of the taper desired for the particular root canal being treated.

Lateral seals for the treated canals are created when the root canal paste cement and the softened gutta percha or other malleable end are condensed vertically and laterally with instruments.

The malleable end of the endodontic post can also be tempered and formed both extra canal and then intra canal, or both.

For example, assembly of the malleable ends 604, 704 of the posts 601 and 701 can be accomplished outside the canal in a separate conditioning unit, such as the oven in FIG. 29, that tempers or conditions the material before insertion into the root canal. After the appropriate malleable end is chosen, it can be treated by the intra-canal methods shown in FIGS. 18-24.

In summary, the entire post and sealer assembly embodies a post with an incisal or occlusal end that is flexible like dentin and the lower or apical sealer end to be bendable enough to negotiate the curves of the canal.

We claim:

1. The method of sealing an endodontic post in place in the root canal of a tooth comprising the steps of:
applying sealing material in a tangible aggregate to an apical end of an endodontic post;
inserting the endodontic post into a root canal of a tooth, an apical end of said endodontic post being set into a bottom apex of said root canal; and,
applying sufficient energy to said sealing material to plasticize and cure said sealing material.

2. The method of claim 1 in which said sealing material aggregate is integral with said endodontic post.

3. The method of claim 1 in which said sealing material aggregate is attached to said endodontic post.

4. The method of claim 1 in which said energy is applied before said post is inserted into said canal.

5. The method of claim 1 in which said energy is applied after said post is inserted into said canal.

6. The method of claim 1 in which said sealing material aggregate is partially cured before insertion into said root canal and completely cured after said post is in place within said root canal.

7. The method of claim 1 in which said sealing material aggregate is attached to said apical end of said endodontic post.

8. The method of claim 1 in which said energy is heat.

9. The method of claim 8 in which heat to said sealing material aggregate is conveyed through a heat conductive wire passing from said sealing material through said post and out of an apical end of said post.

10. The method of claim 9 in which said heat is introduced into said heat conductive wire by a resistive heat probe.

11. The method of claim 8 in which said heat is delivered to said sealing material aggregate by ultrasonic energy.

12. The method of claim 8 in which said heat is delivered to said sealing material aggregate by microwave energy.

13. The method of claim 12 in which said heat is delivered by using the post as a microwave waveguide.

14. The method of claim 1 in which said energy is light.

15. The method of claim 14 in which said light energy is delivered by at least one optic transmissive fiber.

16. The method of claim 1 in which said energy is a chemical reaction.

17. An endodontic post for mounting in a root canal of a tooth comprising:
an extended post having an apical end adapted to be bonded in the root canal with the apical end located adjacent a bottom of said root canal;
a tangible sealing material aggregate being attached to the apical end of said post; and
means to energize said sealing material aggregate sufficient to plasticize and cure said sealing material aggregate.

18. The endodontic post of claim 17 in which said means to energize said selling material aggregate includes means to transfer heat to said sealing material aggregate after said post is in place within said root canal.

19. The endodontic post of claim 18 in which said means to transfer heat includes a heat conductive wire extending from said sealing material aggregate through said post to the apical end of said post.

20. The endodontic post of claim 18 in which said post is constructed to act like a microwave waveguide, and a microwave generator for delivering heat to said sealing material aggregate through said post acting as a microwave waveguide.

21. The endodontic post of claim 17 in which said means to energize said sealing material aggregate comprises at least on light transmissive optical fiber.

22. The endodontic post as in claim 17 in which said means to energize said sealing material aggregate is a hand held heater.

23. The endodontic post as in claim 17 in which said means to energize said sealing material aggregate is an oven.

24. The endodontic post as in claim 17 wherein said sealing material aggregate is energized outside of a root canal.

25. The endodontic post as in claim 17 wherein said sealing material aggregate is energized inside of a root canal.

26. The endodontic post as in claim 17 wherein said sealing material aggregate is partially energized outside of a root canal and partially energized inside of a root canal.

27. The endodontic post as in claim 17 in which said sealing material aggregate is gutta percha.

28. The endodontic post as in claim 17 in which said sealing material aggregate is a composite.

29. The endodontic post as in claim 17 in which said sealing material aggregate is a resin.

30. An endodontic post for placement in a root canal of a tooth comprising:
an extended post having an apical end and a proximate end adapted to be bonded in the root canal with the apical end located adjacent a bottom of said root canal;
a tangible sealing material aggregate being attached to the apical end of said post;
a sealed package surrounding said post and sealing material aggregate in a pre preg semi-malleable state; and,
means to cure said sealing material aggregate sufficient to cure said sealing material aggregate from said pre preg semi-malleable state to a cured state, said means comprising an energy provider.

31. The endodontic post as in claim 30 in which said energy provider is a heat source and said sealing material aggregate includes a heat curable sealing material.

32. The endodontic post as in claim 30 in which said energy provider is a light source and said sealing material aggregate includes a light curable material.

33. The endodontic post as in claim 30 in which said energy provider is a chemical reaction.

34. An endodontic post for mounting in a root canal of a tooth comprising:
an extended post having an apical end and a proximate end adapted to be bonded in the root canal with the apical end located adjacent a bottom of said root canal;
a tangible sealing material aggregate being attached to said apical end of said post;
said sealing material aggregate being attached to said apical end of said post by a circumferential detent in said post.

35. The endodontic post as in claim 34 further comprising a stop provided at said apical end of said post preventing said post from intruding beyond said apical end of said tooth canal into peri-apical tissues below the root canal.

36. An endodontic post for mounting in a root canal of a tooth comprising:
an extended post having an apical end and a proximate end adapted to be bonded in the root canal with the apical end located adjacent a bottom of said root canal;
a tangible sealing material aggregate attached to said apical end of said post;
said sealing material aggregate being attached to said apical end of said post by a press fit joining a bottom of said post within a wrap-around cavity in an adjoining portion of said sealing material aggregate.

37. The endodontic post as in claim 36 further comprising a stop provided at said apical end of said post preventing said post from intruding beyond said apical end of said tooth canal into peri-apical tissues below the root canal.

38. An endodontic post for mounting in a root canal of a tooth comprising:
an extended post having an apical end and a proximate end adapted to be bonded in the root canal with the apical end located adjacent a bottom of said root canal;
a tangible sealing material aggregate being attached to said apical end of said post; and,
a stop provided at said apical end of said post preventing said post from intruding beyond said apical end of said tooth canal into periapical tissues below the root canal.
